(19) United States
(12) Patent Application Publication
(10) Pub. No.: US 2023/0078009 A1
(43) Pub. Date: Mar. 16, 2023

(54) FITNESS TRACKING SYSTEM AND METHOD OF OPERATING THE SAME

(71) Applicant: TRAIN FITNESS INC., Huntsville (CA)

(72) Inventors: Robert Andrew JUST, Toronto (CA); Antoine NEIDECKER, Vancouver (CA)

(21) Appl. No.: 17/944,916

(22) Filed: Sep. 14, 2022

Related U.S. Application Data
(60) Provisional application No. 63/244,430, filed on Sep. 15, 2021.

(51) Int. Cl. A63B 71/06

(52) U.S. Cl. CPC A63B 71/0622; A63B 2024/0065

(57) ABSTRACT

Fitness tracking devices and methods of operating the same. The fitness tracking device includes a sensor circuit to generate sensor data; a processor coupled to the sensor circuit; and a memory coupled to the processor and storing processor-executable instructions that, when executed, configure the processor to: buffer sensor data associated with motion of the user limb; generate an exercise prediction based on a prediction model and the sensor data, the prediction model defined by one or more oscillating signal profiles to identify genus predictions for respective limb movement types about at least one sensor axis, wherein the exercise prediction is generated based on a combination of an identified genus prediction associated with the generated sensor data and environment data associated with motion of the user limb; and transmit a signal representing the exercise prediction for display on a user interface.

### CROSS REFERENCE TO RELATED APPLICATIONS

This application claims priority from U.S. Provisional Pat. Application No. 63/244,430, entitled “FITNESS TRACKING SYSTEM AND METHOD OF OPERATING THE SAME”, filed on Sep. 15, 2021, the entire contents of which are hereby incorporated by reference herein.

### FIELD

Embodiments of the present disclosure generally relate to fitness tracking systems.

### BACKGROUND

Computing devices may include mobile computing devices, wearable computing devices, among other examples. Mobile computing devices may include smartphones. Wearable computing devices may include smart watches, fitness tracking bands, smart eyewear, smart garments, or wireless audio devices, virtual reality (VR) headsets, VR remotes, among other examples. In some situations, wearable computing devices or mobile computing devices may be worn on or proximal to a user’s body throughout a day, or during the course of an exercise routine.

### SUMMARY

The present disclosure describes fitness tracking systems and methods of operating the same. In some embodiments, the fitness tracking systems are configured to conduct operations of a machine learning model for automatically generating exercise activity predictions, associated activity repetition counts, exercise activity form correction feedback signals, or exercise sequence recommendations, among other feedback signals for a user. The exercise activity predictions and associated activity repetition counts may be based on time-series sensor data from one or more wearable computing devices. In some embodiments, the fitness tracking systems provide feedback to a user in substantial real-time during an exercise activity.

In some embodiments, wearable computing devices for generating time-series sensor data representing user movement may include smart watch devices, audio devices (e.g., wireless ear buds), smart garments, fitness tracking bands, among other examples.

In some situations, users may perform physical workout exercises while donning a sole or preferred fitness tracking device, such as a smart watch or other computing device band on the user’s limb (e.g., wrist, ankle, thigh, arm, among other example limb locations). As will be described in the present disclosure, the sole or preferred fitness tracking device may be configured to buffer sensor data associated with motion of the user limb and generate an exercise prediction based on a prediction model. In some embodiments, the prediction model may be defined by oscillating signal profiles, and the prediction model may be configured to generate genus predictions of exercises. In some embodiments, the fitness tracking device may be configured to provide increasingly granular or precise exercise predictions (e.g., species predictions) based on the identified genus predictions and further environment data obtained by the fitness tracking device.

In some other embodiments, a system for generating exercise predictions may include a user’s preferred fitness tracking device and at least one other computing device, respectively having one or more sensor circuits for generating sensor data while a user is performing fitness exercise activity. As will be described in the present disclosure, the system may be configured to provide increasingly granular or precise exercise predictions based on a combination of buffered sensor data at the respective devices (e.g., fitness tracking device, other computing devices, etc.). In some embodiments, other computing devices may include mobile phone devices, wireless acoustic devices having movement sensors thereon, among other examples.

In some embodiments, machine learning model operations for generating exercise predictions may be conducted on a fitness tracking device, such as a smart watch device, and generated exercise predictions and ancillary data may be communicated with a mobile phone device for further communicating with the user. In some embodiments, machine learning model operations may be conducted on a combination of a fitness tracking device and a mobile phone device. Other configurations may be contemplated.

To illustrate, embodiments of the present disclosure may be configured for distinguishing between two or more similar but nonetheless different exercise activities. For example, a user doing bench press exercises with a barbell may exert similar physiological motion of the upper body as a user doing bench press exercises with dumbbells. Accordingly, embodiments of the present disclosure provide devices for generating exercise activity predictions with increased precision or granularity, thereby being able to increase accuracy when distinguishing exercise activities having common physiological motion characteristics but nonetheless being different exercise activities.

Embodiments of fitness tracking systems may be configured to conduct operations of machine learning models based on time-series sensor data associated with user movement, such as movement of user limbs. The time-series sensor data retrieved from wearable fitness tracking device. Such time-series sensor data may be supplemented with time-series data retrieved from another wearable computing device or from other data sources for generating exercise predictions with increasing precision or granularity.

In some embodiments, fitness tracking systems disclosed herein may be configured to predict whether a user is exhibiting proper motion form when partaking in exercise activities. For example, the fitness tracking systems may be configured to identify, based on a combination of sequences of data sets associated with motion detected of the user, potential motions that may unnecessarily cause strain to the user and that may increase the risk of injury to the user. Features of embodiments of fitness tracking devices and systems will be disclosed in the present disclosure.

In one aspect, the present disclosure provides: A fitness tracking device worn on a user limb including a sensor circuit configured to generate sensor data; a processor coupled to the sensor circuit; and a memory coupled to the processor. The memory may store processor-executable instructions that, when executed, configure the processor to: buffer sensor data associated with motion of the user limb; generate an exercise prediction based on a prediction model and the sensor data, the prediction model defined by one or more oscillating signal profiles to identify genus predictions for respective limb movement types about at least one sensor axis, wherein the exercise prediction is generated based on a combination of an identified genus prediction associated with the generated sensor data and environment data associated with motion of the user limb; and transmit a signal representing the exercise prediction for display on a user interface.

In another aspect, the present disclosure provides a method of fitness exercise tracking. The method includes buffering sensor data associated with motion of the user limb; generating an exercise prediction based on a prediction model and the sensor data, the prediction model defined by one or more oscillating signal profiles to identify genus predictions for respective limb movement types about at least one sensor axis, wherein the exercise prediction is generated based on a combination of an identified genus prediction associated with the generated sensor data and environment data associated with motion of the user limb; and transmitting a signal representing the exercise prediction for display on a user interface.

In another aspect, the present disclosure provides a system that may include: a processor; and a memory coupled to the processor. The memory may store processor-executable instructions that, when executed, configure the processor to: receive, from a first wearable computing device, a first series of sensor data associated with user movement; generate an exercise activity prediction based on the first series of sensor data and a fitness model, the fitness model prior-trained using training data sets labelled based on corresponding video data associated with sequences of training sensor data associated with user motion; determine an activity repetition count based on the first series of sensor data and the predicted exercise activity; and generate a user interface to provide the exercise activity prediction and repetition count in substantial real-time during the predicted exercise activity.

In another aspect, the present disclosure provides a method for a fitness tracking system. The method may include: receiving, from a first wearable computing device, a first series of sensor data associated with user movement; generating an exercise activity prediction based on the first series of sensor data and a fitness model, the fitness model prior-trained using training data sets labelled based on corresponding video data associated with sequences of training sensor data associated with user motion; determining an activity repetition count based on the first series of sensor data and the predicted exercise activity; and generating a user interface to provide the exercise activity prediction and repetition count in substantial real-time during the predicted exercise activity.

In another aspect, a non-transitory computer-readable medium or media having stored thereon machine interpretable instructions which, when executed by a processor may cause the processor to perform one or more methods described herein.

In various aspects, the disclosure provides corresponding systems and devices, and logic structures such as machine-executable coded instruction sets for implementing such systems, devices, and methods.

In this respect, before explaining at least one embodiment in detail, it is to be understood that the embodiments are not limited in application to the details of construction and to the arrangements of the components set forth in the following description or illustrated in the drawings. Also, it is to be understood that the phraseology and terminology employed herein are for the purpose of description and should not be regarded as limiting.

Many features and combinations thereof concerning embodiments described herein will appear to those skilled in the art following a reading of the present disclosure.

### DESCRIPTION OF THE FIGURES

In the figures, embodiments are illustrated by way of example. It is to be expressly understood that the description and figures are only for the purpose of illustration and as an aid to understanding.

Embodiments will now be described, by way of example only, with reference to the attached figures, wherein in the figures:

FIG. 1 illustrates a fitness tracking platform, in accordance with embodiments of the present disclosure;

FIG. 2 illustrates a block diagram of a fitness tracking platform, in accordance with embodiments of the present disclosure;

FIG. 3 illustrates an example smart watch device worn by a user partaking in weightlifting exercises, in accordance with embodiments of the present disclosure;

FIG. 4 illustrates a mobile computing device carried by a user in a garment pocket in varying orientations during an exercise activity, in accordance with embodiments of the present disclosure;

FIG. 5 illustrates an example user partaking in a sitting overhead press with dumbbells with a plurality of wearable computing devices, in accordance with embodiments of the present disclosure;

FIG. 6 illustrates a flowchart of a method of transmitting communication messages among computing devices of fitness tracking systems, in accordance with embodiments of the present disclosure;

FIG. 7 illustrates a flowchart of a method of generating predictions of exercise activity types and for generating summary values associated with the identified exercise activity types, in accordance with embodiments of the present disclosure;

FIG. 8 illustrates a flowchart of a method associated with operations for exercise detection, in accordance with embodiments of the present disclosure;

FIG. 9 illustrates a flowchart of a method associated with operations of exercise repetition counting, in accordance with embodiments of the present disclosure;

FIG. 10 illustrates a block diagram of a wearable computing device, in accordance with embodiments of the present disclosure;

FIG. 11 illustrates a flowchart of a method of fitness exercise tracking, in accordance with embodiments of the present disclosure;

FIG. 12 illustrates a graphical plot of acceleration sensor data associated with a X-axis generated by a sensor during an exercise, in accordance with an embodiment of the present disclosure;

FIG. 13 illustrates a graphical plot of acceleration sensor data associated with a X-axis generated by a sensor during an exercise, in accordance with an embodiment of the present disclosure;

FIG. 14 illustrates a graphical plot of sensor data associated with rotation rate about a Y-axis generated by a sensor during an exercise, in accordance with an embodiment of the present disclosure; and

FIG. 15 illustrates a graphical plot of roll sensor data generated by a sensor during an exercise, in accordance with an embodiment of the present disclosure..

### DETAILED DESCRIPTION

The present disclosure describes fitness tracking systems and methods of operating the same.

Mobile computing devices and wearable computing devices may be carried or worn by users during one or more activities. For example, smartphones may be commonly carried by a user in a garment pocket. Smart watches may be worn by a user throughout the course of a day and, in some situations, while sleeping. Wireless audio devices such as ear buds may be worn while exercising, among other activities.

In some embodiments, such mobile computing devices and wearable computing devices may include one or more sensors configured to monitor motion-related or environment-related data associated with a computing device. In some embodiments, sensors may include accelerometers, gyroscopes, pedometers, magnetometers, or barometers, among other examples.

Embodiments of fitness tracking systems described herein may be configured to obtain sensor data sets for determining motion or environment conditions associated with a computing device. For example, motion may include movement such as tilt, shake, rotation, acceleration, or swing. In some situations, determined motion or environmental conditions may correspond to user input, user movement, or the physical environmental conditions associated with the user of the computing device. In some embodiments, environment conditions may be associated with pre-activity or post-activity movements, 3^{rd} party data sets associated with geolocation data, magnetometer data associated with detecting equipment devices, among other examples to be described in the present disclosure.

Based on one or more of determined user movement or physical environmental conditions, the computing device may be configured to predict or infer a type of activity being undertaken by a user. To illustrate, the computing device may be configured to predict that the user may be conducting a particular exercise or activity. Features of exercise tracking systems will be described in the present disclosure.

In some situations, predicting user activity based on a single computing device having one or more sensors may predict some activity types with high accuracy and may predict some other activity types with relatively lower accuracy. For example, when a smartphone may be worn on a user’s hip, the smartphone may be configured to accurately predict user motion associated with running because there may be detectable repetitive motion about the user’s torso region. In another example, when a smartphone may be worn on a user’s hip, the smartphone device may be unable to accurately detect the user undertaking bench press exercises. Bench press exercises may predominantly include motion of the arms and upper body, and the user’s torso region may not experience repetitive or detectable motion representative of bench press exercises.

It may be beneficial to provide fitness tracking systems configured to predict or infer an activity type based on sensor data sets from a combination of devices that may be associated with or worn by the user. In some embodiments, sensor data sets may be obtained from a plurality of computing devices that may already be worn by a user, thereby obviating the need to position dedicated sensors about the user’s limbs or body parts. For example, during workout exercise activity, users may wear a smart watch or, additionally, an audio device (e.g., wireless ear bud device) having sensors embedded therein. Thus, some embodiments of the fitness tracking systems disclosed herein may include operations that leverage sensory capability of devices that otherwise would already worn by users.

In some embodiments described herein, a communication protocol may be provided for transmitting / receiving data messages between fitness tracking devices, smart phone, or other computing devices described herein. In some situations, a smart phone may be configured to transmit messages to and receive messages from a smart watch device, and vice versa. Such example messages may be based on a communication protocol of predominantly ping messages and data messages generated on an as needed basis. In some situations, such communication protocols may not be optimized to support continuous real-time communication of sensor data sets from the smart watch device to the smart phone device, or vice versa. It may be beneficial to provide fitness tracking systems, devices, and methods for managing substantially real-time, continuous data transmission among computing devices of a fitness tracking system.

As will be described in the present disclosure, embodiments of communication protocols for transmission and receipt of messages may be used for signal transmission between two or more wearable devices. For example, in some embodiments, a first wearable computing device (e.g., Apple Watch™) may be configured to generate exercise predictions and determine exercise repetition counts without needing to provide data sets to a smart phone device. Further, the first wearable computing device may receive time-series data sets from a second wearable computing device, and the first wearable computing device may temporally align a combination of time-series data sets for providing exercise predictions and exercise repetition counts. Such embodiments will be described in the present disclosure.

As in some above-described examples, computing devices (e.g., smart phones, smart watches, among other devices) may be configured to predict or infer a type of activity being undertaken by a user based on data sets received from one or a combination of sensor devices. In some situations, a computing device may be configured to predict or infer the type of activity with relatively high precision (e.g., that a user is running on a treadmill or is running outside). In some other situations, the computing device may not be able to discern between two or more similar but nonetheless different activities. For example, a user performing bench press exercises using a Smith machine may exert similar physiological motion of the upper body as a user doing bench press exercises with a barbell. In some situations, the computing device may be able to distinguish the above-described exercises, albeit with less than optimal confidence levels.

It may be beneficial to provide fitness tracking systems configured to predict or infer an exercise activity type with increased precision or confidence levels / scores, thereby being able to increase accuracy when distinguishing exercise activities having common physiological motion characteristics but nonetheless are different exercise activities.

As described, some embodiments disclosed herein may be based on a user donning a sole or preferred fitness tracking device, such as a smart watch or other computing device band on the user’s limb during exercise activity. The sole or preferred fitness tracking device may be configured to generate exercise predictions, determine exercise repetition counts, among other examples of operations.

Some other embodiments disclosed herein may be based on a combination of a user donning a preferred fitness tracking device and a mobile computing device (e.g., smart phone, wireless acoustic device, etc.) operating collaboratively for generating and buffering sensor data at the respective devices, and subsequently generating exercise predictions, determining exercise repetition counts, among other examples of operations.

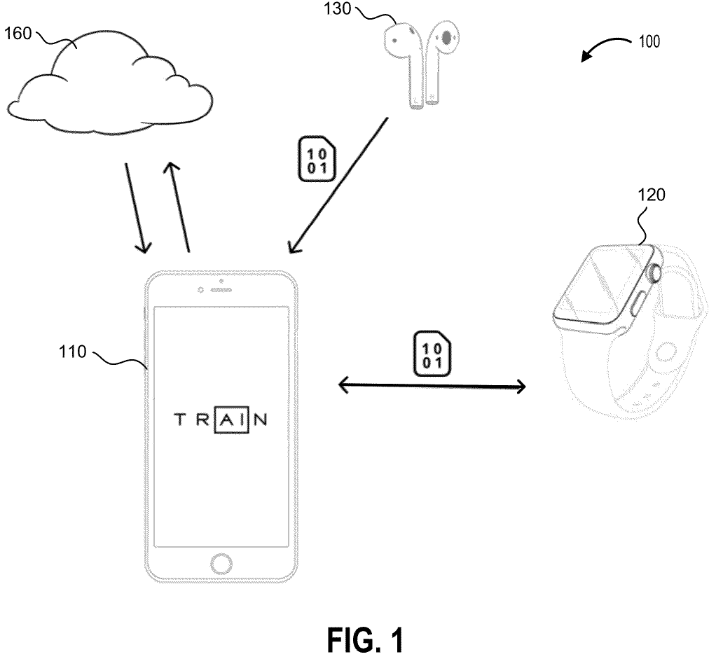

Reference is made to FIG. 1, which illustrates a fitness tracking platform 100, in accordance with an embodiment of the present disclosure. The fitness tracking platform 100 may include a mobile computing device 110. In some embodiments, the mobile computing device 110 may be a smartphone or a pocket personal computer, among other examples, and the mobile computing device 110 may be configured to transmit or receive, via a network, data messages to / from one or more client devices. In the illustrated embodiment of FIG. 1, the mobile computing device 110 may be configured to conduct operations of machine learning models for generating exercise predictions or determining exercise repetition counts, among other operations, based on sensor data generated at the plurality of other devices of the fitness tracking platform 100. It may be contemplated that operations of machine learning models may be distributed, solely or in part, to other devices of the fitness tracking platform 100.

In some embodiments, client devices may include a smartwatch device 120, an audio device 130, or other wearable computing devices, such as fitness tracking bands, smart eyewear, among other examples. In FIG. 1, two example client devices may be the smartwatch device 120 and a pair of earbud audio devices 130. In some other embodiments, the fitness tracking platform 100 may include a single client device, or may include any other number of client devices.

In some embodiments, the fitness tracking platform 100 may be configured to transmit or receive, via the network, data messages to and from a data server 160. In some embodiments, the data server 160 may be a centralized application server, Software as a Service (SaaS) computing platform, among other examples.

As will be described with reference to examples in the present disclosure, the data server 160 may be configured with operations to manage features of the fitness tracking platform 100, to provide social media-based functionality for a plurality of users, or to provide distributed computing operations for machine learning models for predicting or inferring types of activity based on data sets representing user movement or physical environmental conditions corresponding to the user. The data server 160 may be configured with other operations.

Embodiments of the fitness tracking system 100 may include machine learning models for generating predictions of type of user activity and for determining exercise activity statistics to provide feedback to the user. The machine learning models may be trained by training data sets prepared based on sensor data sets associated with video footage of users partaking in exercise activities.

For example, training data sets may be generated by: obtaining sensor data from a smart watch, and simultaneously recording and associating video footage of a user conducting exercises (e.g., running, bench presses, pushups, rowing machine exercises, etc.). To illustrate, the sensor data may represent physiological user motion based on gyroscope sensor data and/or accelerometer sensor data recorded at a rate of up to 100 samples per second. Other sensor data sampling rates may be used.

In some embodiments, operations may be conducted to process the training data set by grouping data sets into subsets and labelling respective subsets as: (0) noise data (e.g., user likely not performing any recognizable fitness activity); (1) concentric motion, representing physiological motion when a user’s muscle fibers may be shortening; (2) mid-point of an exercise activity repetition; or (3) eccentric motion, representing physiological motion when the user’s muscle fibers may be lengthening under load (e.g., negative motion). Other training data set labels may be used.

In some embodiments, operations of the machine learning models for generating predictions and for generating exercise activity statistics may be conducted at the mobile computing device 110, at the data server 160, or a combination of the aforementioned devices.

In some embodiments, the training data sets may be augmented or altered for performing feature engineering and to train the machine learning models. For example, subsets of obtained sensor data may be altered to simulate potential exercise behaviors of fitness enthusiasts. Feature engineering operations may include increasing the speed at the front end of an exercise activity set or decreasing the speed at the back end of an exercise activity set to simulate explosive activity repetitions and fatigue, respectively. In some other examples, feature engineering operations may include operations to rotate or transform sensor data signals to simulate different user body types, body builds, among other user characteristics.

In some embodiments, the machine learning models may be configured to detect exercise activity types, when the exercise activity begins, or when the exercise activity ceases. In some embodiments, the machine learning models may be configured to track the number of exercise activity repetitions.

In some embodiments, the machine learning models may be configured to recommend or predict resistance weight that a user can attempt to use based on prior user performance. In some embodiments, the machine learning model may be iteratively trained or improved to reduce occurrences of false positive detection of activity type.

In some embodiments, the machine learning models may be trained to detect or recognize a specified number of exercise activities. The machine learning models may generate predictions of exercise activity types based on prior generated motion filters.

In some other embodiments, the machine learning models may be configured to recognize or generate additional exercise activity types. The recognition or generation of additional exercise activity types may include detecting a user perform the “new” exercise activity for at least 5 sets of repetitions. For example, a user may begin a new sequence of exercise motions (e.g., “twisty-jump-spin-lunge”) and may want to track this sequence of physical activity. The machine learning models may generate custom motion filters for dynamically detecting and tracking such “new” exercise activity.

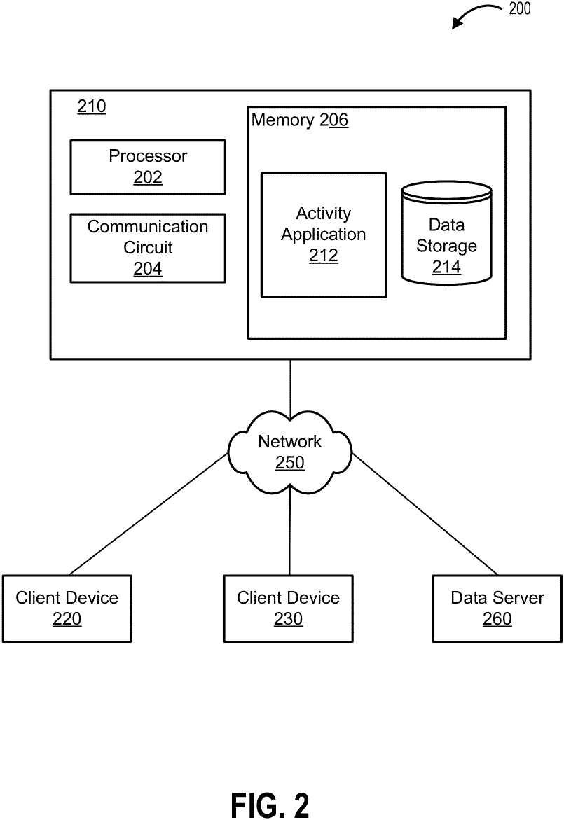

Reference is made to FIG. 2, which illustrates a block diagram of a fitness tracking platform 200, in accordance with embodiments of the present disclosure. The block diagram of the fitness tracking platform 200 may be an example of the fitness tracking platform 100 illustrated in FIG. 1.

A mobile computing device 210 may be configured to transmit or receive, via a network 250, data messages to or data messages from client devices (220, 230) or a data server 260. Two example client devices (220, 230) and a sole data server 260 are illustrated in FIG. 1. In some other examples, any number of client devices or subscription devices may be used.

To illustrate features of the fitness tracking system 200, the mobile computing device 210 may be a smart phone device. The smart phone device may be configured to communicate with client devices (220, 230) such as a smart watch device worn by a user or a pair of ear bud devices via the network 250. The smart phone device may be configured to communicate with the data server 260, such as a SaaS server or similar computing device, via the network 250.

In some embodiments, the mobile computing device 210 may communicate with the respective client devices (220, 230) or the data server 260 based on a common network communication protocol or based on different network communication protocols. For example, communication between the mobile computing device 210 and the client devices (220, 230) may be based on near-field communication protocols and the communication between the mobile computing device 210 and the data server 260 may be based on other wired or wireless network mediums.

For example, the network 250 may include a wired or wireless wide area network (WAN), local area network (LAN), a combination thereof, or other networks for carrying telecommunication signals. In some embodiments, network communications may be based on HTTP post requests or TCP connections. Other network communication operations or protocols may be used.

For example, the network 250 may include near-field communication networks, such as Bluetooth™ networks, among other examples. In some examples, the network 250 may include the Internet, Ethernet, plain old telephone service line, public switch telephone network, integrated services digital network, digital subscriber line, coaxial cable, fiber optics, satellite, mobile, wireless, SS7 signaling network, fixed line, local area network, wide area network, or other networks, including one or more combination of the networks.

The mobile computing device 210 includes a processor 202 to implement processor-readable instructions that, when executed, configure the processor 202 to conduct operations described herein. For example, the mobile computing device 210 may be configured to obtain data sets representing sensor data associated with physiological motion of a user and to dynamically generate predictions of user activity type or activity metrics in substantial real-time to the user. Other example operations will be described herein.

The processor 202 may be a microprocessor or a microcontroller, a digital signal processing processor, an integrated circuit, a field programmable gate array, a reconfigurable processor, or combinations thereof.

The mobile computing device 210 includes a communication circuit 204 configured to transmit or receive data messages to or from other computing devices, to access or connect to network resources, or to perform other computing applications by connecting to a network (or multiple networks) capable of carrying data. In some examples, the communication circuit 204 may include one or more busses, interconnects, wires, circuits, or other types of communication circuits. The communication circuit 204 may provide an interface for communicating data between components of a single device or circuit.

The mobile computing device 210 includes memory 206. The memory 206 may include one or a combination of computer memory, such as random-access memory, read-only memory, electro-optical memory, magneto-optical memory, erasable programmable read-only memory, and electrically-erasable programmable read-only memory, ferroelectric random-access memory, or the like. In some embodiments, the memory 206 may be storage media, such as hard disk drives, solid state drives, optical drives, or other types of memory.

The memory 206 may store an activity application 212 including processor-readable instructions for conducting operations described herein. In some examples, the resource application 212 may include operations for conducting machine learning operations associated with activity type prediction, operations associated with a recommendation application for providing exercise training recommendations in substantial real-time to a user during user exercise activity, or other example operations described in the present disclosure.

The mobile computing device 210 includes data storage 214. In some embodiments, the data storage 214 may be a secure data store. In some embodiments, the data storage 214 may store data sets received from the client devices (220, 230) or the data server 260. The data store 214 may be configured as a repository for data sets representing sensory data or other associated metadata from data-rich devices, such as smart watch devices, ear bud devices, smart garments, fitness tracker bands, among other devices (e.g., client devices 220, 230 or the data server 260).

Respective client devices 220, 230 may be wearable computing devices such as smart watches, fitness tracking bands, smart eyewear, smart garments, wireless audio devices, among other examples. The wearable computing devices may be devices that a user may have adopted to wear routinely for one or more user exercise activities, such as while working out at a gym or exercising outdoors. The respective client devices 220, 230 may be configured as data-rich devices including sensors for detecting motion, patterns inherent in a sequence of motions, identifiable characteristics of detected motion, physical environment conditions, among other sensor-acquired data.

The respective client devices 220, 230 may include a processor, a memory, or a communication interface, similar to the example processor, memory, or communication interface of the mobile computing device 210. In some embodiments, the respective client devices 220, 230 may be computing devices associated with a local area network for transmitting or receiving signals to or from the mobile computing device 210. The local area network may include a wireless local area network or near-field communication networks such as Bluetooth™ or the like.

The data server 160 may be a computing device such as a data server, database device, or other data storing system for providing remote computing resources. For example, the data server 160 may conduct operations for managing or combining data sets from a plurality of mobile computing devices 210, where respective mobile computing devices 210 may conduct operations of the activity application 212.

In some embodiments, the data server 160 may be configured to provide gamification features or social media-related features to a plurality of users. For example, users of respective smartphone devices may opt to “follow” other users within a social network and compare exercise activity metrics with other users. In some examples, providing social-media related features can foster a community associated with exercise and healthy user lifestyles. In some embodiments, shared exercise activity metrics may be shared or kept private from other respective users.

In some embodiments, the data server 160 may provide gamification features to generate community competitions to incite friendly rivalry, and exercise activity level achievement rewards may be provided when users reach specific exercise activity level goals. In some embodiments, social media-related features may provide “leader boards” based on social groups associated with fitness centers attended, user profession, geographical location, age, or custom user groups. Social media-related features may motivate users to strive for and achieve fitness goals generated by the activity application 212 or created by respective users.

In some embodiments, the data server 160 may be configured to generate non-fungible tokens that may be stored on a blockchain. The non-fungible tokens may be based on a plurality of data sets associated with exercise activity of users. For example, the plurality of data sets associated with the exercise activity of users may include total weights lifted during exercises, physiological data or health metrics (e.g., heart rate, hart rate variability, blood pressure, among other examples), types of exercise activity, or photos associated with the exercise activity.

In some embodiments, the data server 160 may be configured to conduct comparisons of data associated with non-fungible tokens with data associated with other users, such as social media influencers, athletes, or the like, to generate a gamified exercise experience. In some embodiments, non-fungible tokens associated with exercise activity of users may be transferred or sold to other users.

In some embodiments, the data server 160 may be configured to provide on-going fitness activity coaching and motivation to a user. For example, the data server 160 may retrieve signals from the mobile computing device 210 representing user-provided lifestyle or health goals. The data server 160 may be configured to monitor user exercise activity levels for determining when specific lifestyle or health goals may have been achieved and, subsequently, provide achievement badges or other encouragement rewards.

For example, the data server 160 may be configured to monitor when a user’s weightlifting goals have been reached or exceeded and, subsequently, provide achievement badges representing their personal best goals (e.g., 1,000 pound weightlifting club). In some embodiments, achievement badges may be associated with user loyalty, such as regular user for X amount of time, premium member for X amount of time, or specified number of completed workouts.

In some embodiments, the data server 160 may be configured to manage premium memberships associated with the activity application 212, such that in exchange for a specified number of achievement badges, a user may be provided a premium membership for the activity application 212 for a given duration of time. In another example, the data server 160 may be configured to keep track of the number of achievement badges associated with a user and provide a discounted or time-limited premium membership for the activity application 212 to that user.

Example operations of the data server 260 described above may, in some embodiments, be conducted on the mobile computing device 210, or may be conducted on a combination of the data server 260 and the mobile computing device 210.

In some embodiments, the data server 260 may be configured to provide an artificial intelligence-based chat-bot to users of the activity application 212, such that respective users of the mobile computing device 210 may be able to send messages via the activity application 212 and receive fitness training / recommendations for their exercise activity workouts.

Embodiments of fitness tracking systems described herein may be configured to generate or obtain data sets representing sensor data from one or more data-rich devices (e.g., smartphone or wearable computing devices), dynamically track user exercise activity while the user may be at a gym, generate based on machine learning models predictions of specific user exercise activity type, and/or dynamically generate recommendations to the user during the user exercise activity. As such, embodiments of fitness tracking systems described herein may provide features of a virtual strength-training application for automatically identifying whether a user is doing squats or bench presses, push-ups or sit ups, or tally exercise repetitions. Further, the fitness tracking systems may be configured to generate user exercise activity metrics, such as rest time, range of motion, velocity, or the like, that may be transmitted to a live coach or trainer for progress monitoring.

To illustrate embodiments, the following examples illustrate a user who may be wearing or carrying at least one of a smart watch (e.g., Apple Watch™, or the like), wireless ear buds having one or more motion sensors therein (e.g., Apple AirPods™, or the like), or a smart phone (e.g., Apple iPhone™, Android-based smart phone, or the like) during an exercise or workout session. During a user’s exercise activity, the smart phone may conduct operations of an activity application 212 (FIG. 2) for obtaining substantially continuous, real-time data sets from the smart watch, wireless ear buds, or other user wearable devices for generating in substantial real-time predictions of the type of exercise activity that the user may be partaking in. The activity application 212 may provide one or more of the above-described generated predictions as feedback to the user via graphical user interfaces or audio interfaces.

In some embodiments, the activity application 212 may conduct operations to automatically detect the start of a workout activity and an end of the workout activity, without obtaining user input to indicate the start or conclusion of the workout activity. Upon detecting a start of a workout activity, the activity application 212 may be configured to dynamically generate a user interface for display at the smart watch or the smart phone. The user interface may be configured to provide a list of at least one predicted exercise associated with the machine learning model output, and the user may provide feedback on whether the predicted exercise activity prediction(s) may be accurate. In some embodiments, such user feedback may be utilized for improving or training the machine learning model.

The activity application 212 may in substantial real-time one or a plurality of exercise activity statistics or details, such as range of user motion, velocity, acceleration, detected user rest time, physiological metrics of the user (e.g., heart rate, etc.) for providing the user with guidance or motivation through the exercise activity. Upon detecting a conclusion of the activity exercise or a repetition set, the activity application 212 may generate a summary of the user’s activity exercise. Data sets generated during user exercise activity may form the basis of training data sets for improving machine learning model output, and may form the basis for providing future exercise activity guidance.

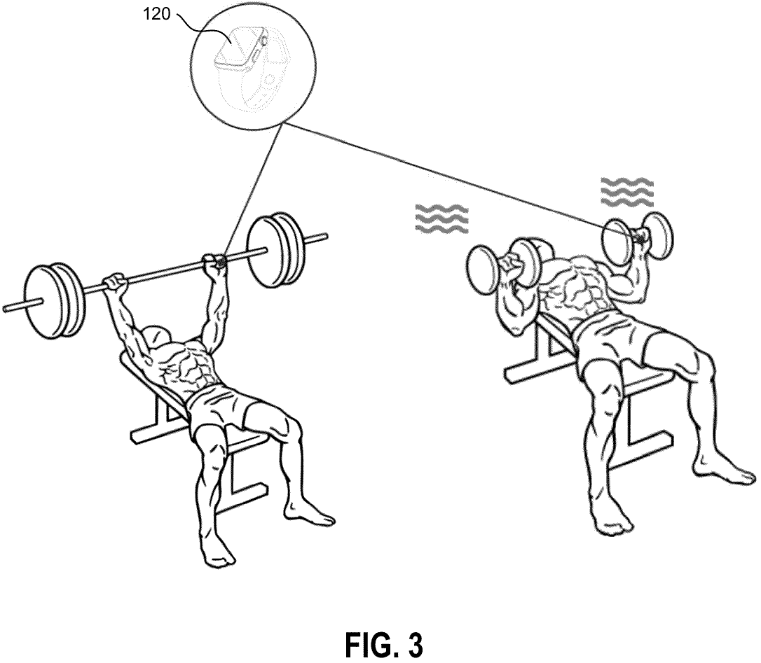

Reference is made to FIG. 3, which illustrates an example of a smart watch device 120 (FIG. 1) worn by a user partaking in weightlifting exercises, in accordance with embodiments of the present disclosure. The user may be wearing the smart watch device 120 on a wrist of the user.

In some embodiments, the smart watch device 120 may include one or more sensors configured to detect motion representing user movement or physical environment conditions. For example, the smart watch device 120 may include one or more of an accelerometer, a gyroscope, a magnetometer, or other sensors for detecting acceleration, gyroscopic motion, gravity, or magnetic field during exercise activity. Data sets associated with the detected motion may be for deriving or predicting the exercise activity type by the user.

FIG. 3 illustrates the user doing weightlifting exercises, such as bench presses with a barbell and, alternatively, with dumbbells. As the user may be wearing a smart watch device 120, the smart watch device 120 may generate a series of sensor data, and the series of sensor data may be used for generating predictions on the type of weightlifting exercise by the user.

Although both drawings in FIG. 3 show a user conducting bench press exercises, the respective drawings illustrate the user conducting bench press exercises based on different equipment. In some embodiments, the activity application 212 (FIG. 2) may conduct operations for distinguishing the type of activity / equipment used by the user based on characteristics derived from sequences of sensor data.

In one example, the user may be conducting bench press exercises with a barbell. In another example, the user may be conducting bench press exercises with dumbbells. The user’s wrist motion when conducting bench presses with a barbell may be different than the user’s wrist motion when conducting bench presses with dumbbells, at least because there may be greater variation in wrist movement when pushing up on dumbbells as compared to wrist movement when pushing up on a barbell.

In some situations, a user may be conducting one or more exercises associated with common physiological motion characteristics, but may be different in user positioning. For example, a user partaking in bench press exercises with a barbell may exhibit upper body or arm motion, as detected by one or more sensors by a smart watch, similar to upper body or arm motion exhibited with the user partaking in overhead press exercises. However, the user partaking in bench press exercises may be lying down on a bench, whereas the user partaking in overhead press exercises may be in a partially upright, standing position. It may be beneficial to provide fitness tracking system features to combine data sets from two or more client devices to predict or infer an activity type with increased confidence levels / scores, thereby being able to increase exercise prediction accuracy to distinguish exercise activities having common physiological motion characteristics, but that may nonetheless be different exercise activities.

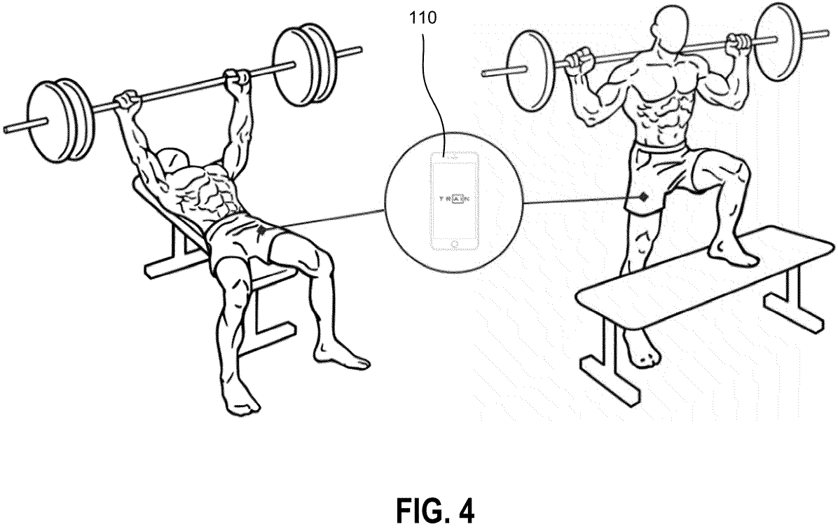

Reference is made to FIG. 4, which illustrates the mobile computing device 110 (FIG. 1) carried by the user in a garment pocket, in accordance with embodiments of the present disclosure. In FIG. 4, the user may also be wearing a smart watch device (not explicitly illustrated in FIG. 4).

The mobile computing device 110 may be in communication with the smart watch device, and may obtain substantially continuous, real-time data sets from the smart watch device representing physiological motions of the user’s wrist / arm movement.

The drawings in FIG. 4 illustrate the user partaking in bench press exercises and the user, subsequently, partaking in standing press exercises. The mobile computing device 110 may conduct operations of the fitness application 112 (FIG. 1) for predicting that the user is partaking in one of either bench press exercises or standing press exercises. In the present example, the motion detected by the smart watch device when the user partakes in bench press exercises or the standing press exercises may be similar. The mobile computing device 110 may generate a prediction on the type of exercise being conducted, and may display the predictions on a user interface for the user to confirmation input on.

To increase confidence levels / scores associated with predicting the exercise activity by the user, the computing device 110 may in some embodiments generate predictions based on data sets from two or more computing devices. In the example illustrated in FIG. 4, the orientation of the mobile computing device 110 in three dimensional space may be different when: (i) the user is lying on a bench when partaking bench press exercises; and (ii) the user is in a substantially standing position when partaking in standing overhead press exercises.

Thus, in some embodiments, the mobile computing device 110 may predict the exercise activity type of the user based on a combination of sensor data sets from the smart watch device and based on orientation data sets associated with the mobile computing device 110. For example, when the mobile computing device 110 is in an upstanding position relative to the earth, the user is less likely to be performing bench press exercises when upper body / arm movements are detected. Further, when the mobile computing device 110 is in a position substantially parallel to the earth (e.g., when the user is lying down on a bench with the mobile computing device 110 is in the user’s garment pocket), the user is less likely to be performing standing overhead press exercises. Thus, embodiments of the fitness tracking system described herein may be configured to generate predictions associated with user motion as detected by one or a combination client devices (e.g., smart watch devices, smart garments, etc.) and to track user motion for generating a series of exercise activity records.

In some embodiments, the mobile computing device 110 may aggregate or combine the series of exercise activity records for storage at a data storage or for transmission to a remote / off-site data server 160. Aggregation of data sets from data-rich computing devices may be the basis for predicting exercise activity based on a plurality of data sets associated with users across user body types, geographies, profiles, or the like. Data sets associated with exercise activities of a pool of users may be used for predicting exercise activities of individual users. Machine learning models of the activity application 212 (FIG. 2) may be iteratively trained and dynamically re-trained for improving exercise activity predictions.

Embodiments of the activity application 212 (FIG. 2) may include operations for detecting type of equipment that a user may be partaking in. As an example, referring again to FIG. 3, the user may be partaking in bench press exercises. In one drawing, the user may be conducting bench presses with a barbell. In another drawing, the user may be conducting bench presses with dumbbells.

It may be beneficial to provide methods of increasing confidence scores / levels of exercise activity predictions based on detection of user motion associated with pre-activity or post-activity. For example, the user may be setting up for conducting bench presses with a barbell, the user may place disc weights at opposing sides of the barbell. The mobile computing device (not explicitly illustrated in FIG. 3) may conduct operations for detecting motion characteristic of a user placing disc weights on opposing sides of the barbell (via sensors on the smart watch device and data sets transmitted to the mobile computing device), such that these detected motion characteristics may be combined with data sets obtained during the actual exercise activity for predicting that the user may be partaking in bench presses with a barbell.

Further, when the user may be handling a barbell for bench press exercises, the mobile computing device may detect that the user motion may suggest the equipment substantially moving along a single axis (e.g., vertically relative to the earth), and may predict that a barbell is being used for exercises.

In contrast, when the user may be setting up for conducting bench presses with dumbbells, the user may pick up respective dumbbells and may exhibit wrist rotation motion to setup the dumbbells in the desired position for the bench press operations. For example, the mobile computing device 110 may conduct operations to identify that equipment being handled based on user motion is about multiple axis, thereby suggesting that dumbbells may be used by the user.

Accordingly, the mobile computing device (not explicitly illustrated in FIG. 3) may conduct operations for detecting motion characteristics of a user rotating dumbbells into a desirable position for bench press exercises, such that these detected motion characteristics may be combined with data sets obtained during the actual exercise activity for predicting that the user may be partaking in bench presses with dumbbells.

In some embodiments, the mobile computing device 212 (FIG. 2) may be configured to predict the type of equipment used by a user during exercise activities based on other types of sensory data obtained from the smart watch device 120, or other example client devices having sensors. In an example, the mobile computing device 110 may be configured to identify equipment types based on data sets representing magnetic field characteristics about the smart watch device 120. For example, the smart watch device 120 may generate data sets representing a magnetic field profile when the user’s wrist is proximal to a barbell that is different that the magnetic field profile when the user’s wrist is proximal to barbell.

In some embodiments, the mobile computing device 110 may be configured to predict equipment types based on changes to detected magnetic field over time. For example, when a user’s hand approaches a piece of equipment having iron materials, the mobile computing device 110 may identify characteristic changes in magnetic field suggesting equipment composed of iron material, as opposed to equipment with other types of material.

When partaking exercise activity, users may have variation in the form of the motion. In the event that a user may be partaking in an exercise activity with non-optimal motion, the user may increase risk of injury. For example, when a user is partaking in squat exercises with non-optimal body positioning, the user may increase their risk of physical injury. For example, with non-optimal stance that positions the hips, shoulders, among other user body parts, the user may over-extend portions of the body and be subjected to injury. It may be beneficial to provide fitness tracking systems with features for predicting likelihood that the user is exhibiting good motion form for an already / prior-predicted exercise activity based on sensor data sets obtained from a sole fitness tracking device or based on sensor data sets combined from two or more fitness tracking devices.

In some situations, a sole fitness tracking device may be configured to identify or predict likelihood that the user is exhibiting non-optimal exercise form. For example, a fitness tracking device operating as a sole device may identify non-optimal exercise form for bicep curls, among examples of exercise activity. In some other situations, a preferred fitness tracking device in combination with a secondary computing device may be required to generate and combine sensor data for determining or predicting non-optimal exercise form (e.g., deadlifts, etc.).

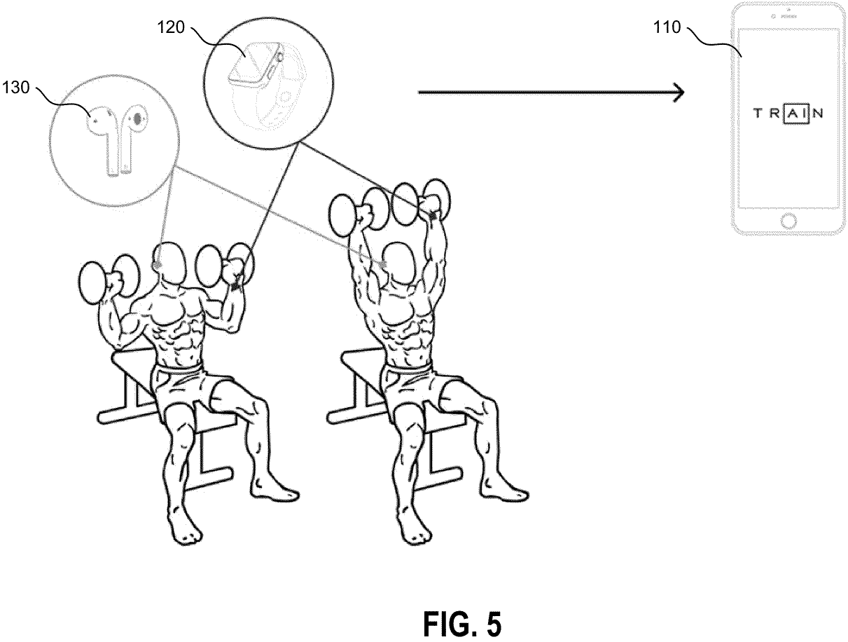

Reference is made to FIG. 5, which illustrates an example user partaking in a sitting overhead press with dumbbells. The user may be wearing a smart watch device 120 (FIG. 1) (e.g., Apple Watch™, or similar device) at the user’s wrist and may be wearing an audio device 130 (FIG. 1) (e.g., Apple AirPods™, or similar device) having one or more motion sensors therein.

In the present example, the smart watch device 120 and the audio device 130 may be configured to be in communication with the mobile computing device 110 (FIG. 1) (e.g., a smart phone device having an activity application operating thereon). The mobile computing device 110 (FIG. 1) may be configured to aggregate and/or combine sequences of data sets representing user motion over time as the user partakes in exercise activity. In the present example, the combined sequences of data sets may represent user motion at the user’s wrist and user head motion during a sitting overhead press exercise sequence with dumbbells.

In some situations, it may be beneficial to monitor the user’s motion form during an exercise activity to reduce the likelihood of injury to the user. For example, when the user is partaking in a sitting overhead press exercise with dumbbells, the user may wish to ensure that the user’s head position relative to the dumbbells is substantially aligned within a plane. Other characteristics of proper exercise activity form may be contemplated.

In the present example, sequences of data sets associated with motion of the user’s head (e.g., based on sensor data from the audio device 130) and sequences of data sets associated with motion of the user’s wrist, in combination and over time, may be used for predicting whether the user is exhibiting proper motion form while partaking in the sitting overhead press exercise.

In some embodiments, the mobile computing device 110 may be configured to identify, based on the combination of sequences of data sets associated with motion of a plurality of body parts of the user, potential motions that may unnecessarily cause strain to the user and that may increase the risk of injury to the user.

Upon identifying potential motions that may be associated with risk of injury to the user, the mobile computing device 110 may be configured to provide feedback to the user in substantial real-time. In some embodiments, the mobile computing device 110 may provide visual feedback via the mobile computing device 110, may provide haptic feedback via the smart watch device 120, and/or may provide acoustic feedback via the audio device 130 to alert the user of potential improper exercise activity form.

In some embodiments, the visual feedback may include messages or general drawings to provide guidance on correcting motion form for the particular exercise activity. In some embodiments, the acoustic feedback may include audio prompts to remind the user to concentrate on tips for correcting exercise activity form. In some embodiments, the haptic feedback may include vibratory alerts at the user’s wrist for indicating that the user may be conducting improper motion form or that the user should follow a timing sequence that may allow the user to concentrate on movements to improve motion form.

In some embodiments, the mobile computing device 110 may be configured to obtain gyroscope data associated with user motion at the user’s wrist (e.g., via smart watch device) for detecting incorrect form in substantially real time. For example, the mobile computing device 110 may be configured to identify whether a user’s hands may be too close together on a barbell during bench press exercise activity (e.g., not maximizing muscle stimulation). The mobile computing device 110 may provide the analysis in near real-time, or may provide the analysis in a post-workout analysis report. In some embodiments, the mobile computing device 110 may identify whether the user may be persistently partaking in exercise activities with improper form and, if identified, may recommend to the user alternative exercise activity for targeting substantially similar muscles whilst reducing the risk of injury.

In some embodiments, upon identifying potential motions that may be associated with risk of injury to the user, the mobile computing device 110 may transmit messages to a predefined party, such as a live personal trainer, and the live personal trainer may be equipped with data driven observations to provide guidance to the user.

In some situations, the mobile computing device 110 may be configured to transmit and receive messages to and from the smart watch device 120. Message transmission and receipt may be based on a defined communication protocols including operations to send ping messages and include data messages that are generated on an as needed (e.g. ad hoc basis). In some situations, such defined communication protocols that may be pre-existing as between two computing devices (e.g., mobile phone, wearable computing watch, wireless acoustic earbuds, among other examples of computing devices) may not be optimal to support continuous real-time communication of sensor data sets from the smart watch device to the mobile computing device, or vice versa. It may be beneficial to provide systems and methods for managing continuous, substantially real-time data transmission among the above-described computing devices associated with embodiments of the fitness tracking system described in the present disclosure.

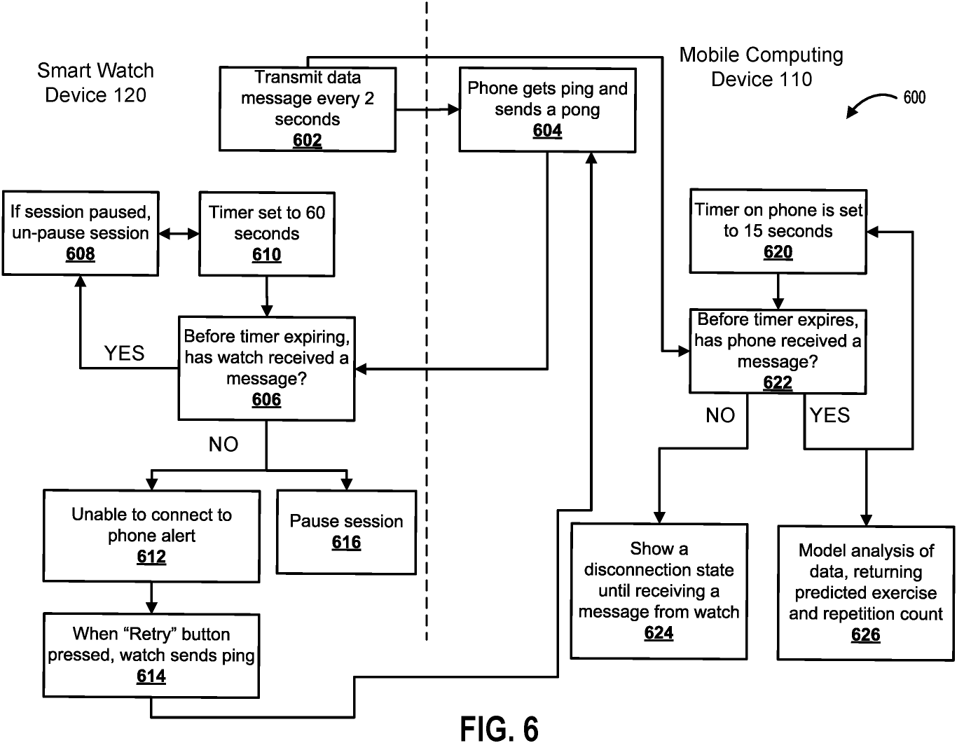

Reference is made to FIG. 6, which illustrates a flowchart of method 600 of transmitting communication messages among computing devices of fitness tracking systems, in accordance with embodiments of the present disclosure. The method 600 illustrated in FIG. 6 may include operations conducted by one or more processors of the mobile computing device 110 and one or more processors of the smart watch device 120, or any other client devices that may include sensor devices and that may interface with the mobile computing device 110 in a fitness tracking system. The method 600 may include operations, such as data retrievals, data manipulations, data storage, or other operations, and may include computer-executable operations.

As described, in some situations, a computing device (e.g., the mobile computing device 110) and smart watch devices 120 (among other example client devices) may be configured to communicate with one another based on a defined or existing communication protocol with features that are based on ping messages and based on messages generated based on an ad hoc basis. Such defined or existing communication protocols may not be optimal for embodiments of fitness tracking systems described herein. The method 600 includes numerous features for leveraging features of the above-defined or existing communication protocols, while being able to support continuous, real-time transfer of sensor data sets among devices of fitness tracking systems. Although examples described herein may be described as between a mobile computing device 110 and a smart watch device 120, embodiments of the communication protocol may be configured as between any other pairs of computing devices.

Further, some examples may be described with the mobile computing device 110 being configured to predominantly conduct machine learning model operations for generating exercise predictions and exercise repetition counts. It may be contemplated that the smart watch device 120 or other computing devices of a fitness tracking system may be configured to predominantly conduct machine learning model operations described herein.

At operation 602, the smart watch device 120 may transmit “ping” data messages to the mobile computing device 110 (herein after also described as the smartphone device) every 2 seconds. It may be appreciated that other time intervals may be used.

At operation 604, the smartphone may receive the “ping” data messages and transmit a “pong” message (akin to an acknowledge message) corresponding to the respective received “ping” data messages.

At operation 606, the smart watch device 120 may determine whether a “pong” message has been received before a threshold time value has expired. If the smart watch device 120 determines that a “pong” message has been received, the smart watch device 606 may be configured to ensure that the smart watch device 606 is currently in an un-paused state, and proceed with conducting embodiments of the fitness tracking system described in the present disclosure.

At operation 610, the smart watch device 120 is configured to set a timer having a threshold time value. In the present example, the threshold time value may be 60 seconds. Other threshold time values may be used.

In the present example, the sequential series of “ping” and “pong” messages may be transmitted as a method of maintaining an active network communication channel as between the smart phone device and the smart watch device 120. In some embodiments, the network communication channel may include a near-field communication channel, or a wireless local area network, among other example networks.

If the smart watch device 120 determines that a “pong” message has not been received prior to a time threshold value expiring, the smart watch device 120 may, at operation 612, determine that the smart watch device 120 is unable to connect to the smart phone device and may, at operation 616, conduct operations to pause the current fitness tracking session.

At operation 614, when the smart watch device 120 determines that a “retry” button is pressed, the smart watch device 120 may transmit a “ping” data message to the mobile computing device 110. The user input at a “retry” button may be received at a user interface provided by the smart watch device 120.

If the mobile computing device 110 detects, at operation 604, the “ping” data message, the smart watch device 120 may be configured to conduct operations 606 and associated subsequent operations as described above.

At operation 620, the mobile computing device 110 may be configured to set a second threshold timer value (e.g., 15 seconds).

Prior to the second threshold timer value expiring, the mobile computing device 110 may determine whether the phone has received a message from the smart watch device 120 or other client devices.

In the event that the mobile computing device 110, at operation 622, determine that a data message has been received before expiry of the second threshold timer value, the processor may at operation 624 generate a message for a user interface to indicate a disconnection state until receiving a subsequent message from the smart watch device 120.

In the event that the mobile computing device 110, at operation 622, determines that a data message (e.g., a “ping” data message, or other messages) has been received, the processor may at operation 626 generate analytical output for providing predicted exercise activity, exercise repetition count data, or other output from embodiment methods described in the present disclosure.

Further, the mobile computing device 110 may reset or set the timer at the mobile computing device 110 for restarting the timer associated with detecting incoming receipt of data messages.

Embodiments of operations of the method 600 of FIG. 6 include features for maintaining a communication channel between a smart phone device and respective client devices (e.g., smart watch device 120, among other examples) whilst leveraging defined or existing network communication protocols as between the smart phone device and respective client devices.

As described herein, embodiments of fitness tracking systems may be configured to predict or infer an activity type based on sensor data sets from a combination of devices that may be associated with or worn by the user. In some embodiments, sensor data sets may be obtained from a plurality of computing devices that may already be worn by a user, thereby obviating the need to position dedicated sensors about the user’s limbs or other anatomical body parts.

In some embodiments, it may be beneficial to identify data records in a sequence of data sets representing motion detection that may be “noise” data and that may be motion associated with exercise activity. In some embodiments, “noise” data may be associated with user motion not associated with an identifiable fitness exercise activity, such as when the user may be routinely walking, may be resting between exercise activity sets, among other examples. “Noise” data may represent user motion that may not have regular cadence or repetition features that may be characteristic of exercise fitness activity.

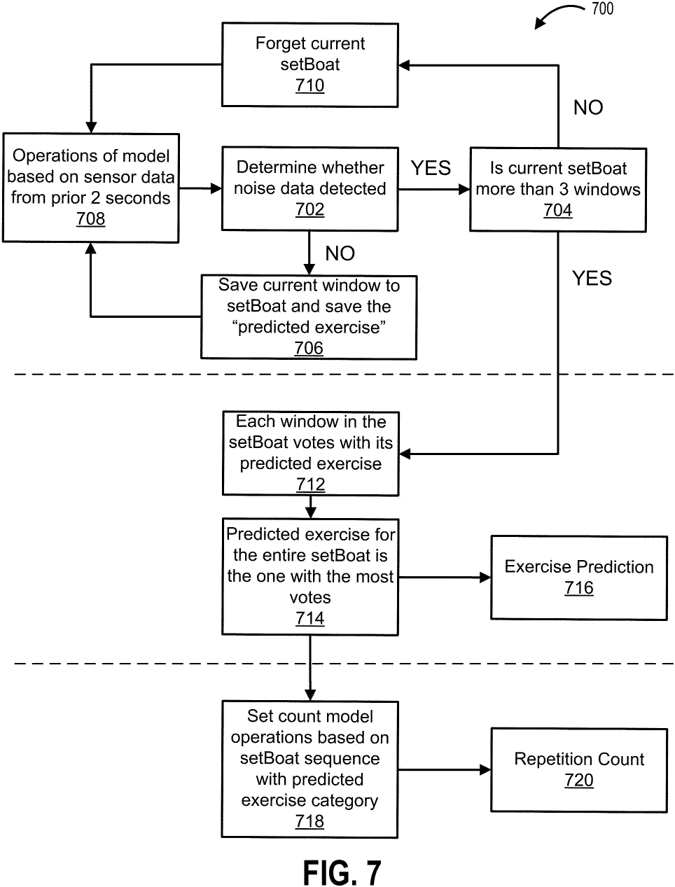

Reference is made to FIG. 7, which illustrates a flowchart of a method 700 of generating predictions of exercise activity types and for generating overall summary values associated with the identified exercise activity types, in accordance with embodiments of the present disclosure. The method 700 may be conducted by the processor of the mobile computing device 110 (FIG. 1, or 210 of FIG. 2). The processor-executable instructions may be stored in memory and may be associated with the activity application 212 (FIG. 2) or other processor-executable applications not illustrated in FIG. 2. The method 700 may include operations, such as data retrievals, data manipulations, data storage, or other operations, and may include computer-executable operations.

The mobile computing device 110 may receive data messages from one or more client devices. As illustrated in examples throughout the present disclosure, the one or more client devices may be wearable computing devices having sensors thereon for detecting motion of the user.

At operation 702, the mobile computing device may determine whether noise data is detected. Noise data may be associated with user motion that does not correspond to an identifiable fitness exercise activity. Sensor data representing user motion corresponding to the user resting between exercise sets, the user walking between exercise activity, among other examples, may be identified as noise data.

In some embodiments, data sets identified as noise data may represent user motion associated with the user placing weights on opposing sides of a barbell and of the user positioning themselves on a bench for partaking in an exercise activity.

In the event that the processor identifies that a set of received sensor data is noise data, the mobile computing device at operation 704 may determine whether the current setBoat is more than 3 windows in length. In some embodiments, “setBoat” may be a memory allocated buffer for storing sequences of received data sets associated with motion of the user. If the “setBoat” is not more than 3 windows large, the processor at operation 710 may discard the currently received set of sensor data that was identified as noise data. The above example utilizes a “3 window” length threshold, however, in other examples, other sized windows may be used.

In the event that the processor identifies that a set of received sensor data is not noise data, the mobile computing device 110 determines that the sensor data represents user motion of an identified user activity. The mobile computing device 110 at operation 706 saves the set of received sensor data (e.g., identified as motion of an exercise activity) to the “setBoat” and may save an exercise activity type prediction.

As an illustration, when a user pushes the barbell upwards during a bench press exercise activity and performs a number of repetitions, machine learning models may predict an exercise activity based on sensor data associated with 2 second time windows. Other durations of time windows may be used. The windows of sensor data may be saved to a “setBoat” with corresponding exercise prediction. The setBoat may be a cumulative list of juxtaposed windows having the predicted exercise activity data. In some embodiments, repetition count of the predicted exercise activity is not determined during the time that the user is partaking in the exercise activity.

At operation 708, the mobile computing device 110 may conduct machine learning model operations based on the prior received sensor data identified as being associated with motion of the user’s exercise activity. The machine learning model may be prior-trained and configured to pre-emptively generate predictions of an exercise activity type.

Referring again to operation 704, where the processor may have determined that a received data record or data set from a client device may be noise data, in the event that the processor determines that the current setBoat includes more than 3 windows of data sets representing sensor data, the mobile computing device 110 at operation 712 may generate a “vote” of a predicted exercise for each of the respective windows of data sets that represent user motion.

In some embodiments, when the mobile computing device 110 obtains sensor data that may be determined to be noise data, that noise data may be associated with the user finishing the exercise activity. Operations may proceed to 712 and 714, where respective windows of sensor data may be associated with votes corresponding to predicted exercise activity.

For example, the mobile computing device 110 may conduct operations of the machine learning model to provide at least 1 predicted exercise activity type (e.g., bench press with barbell, bench press with dumbbells, military press, among other examples). The “voting” process includes identifying a potential exercise activity type.

At operation 714, the processor may generate a predicted exercise for the entire setBoat based on an exercise activity type that has received the greatest number of votes. For example, based on the respective windows of sets of data representing motion of the user during exercise activity, the processor may have associated a vote for a potential exercise activity type with each of the windows of data. To illustrate, among 3 windows of sensor data representing user motion, the processor may have voted that the sensor data for 2 of the 3 windows is more likely to represent a bench press activity with dumbbells, while the remaining 1 window is more likely to represent a bench press activity with a barbell.

The above example illustrates that while one or more exercise activities may have common physiological motion characteristics similar to another exercise activity (e.g., generally bench press), among a plurality of windows of data representing exercise activity, there may be a majority of windows (e.g., representing a data set at a 2 second interval) that are indicative of a most specific variant of an exercise activity (e.g., a bench press activity that is specifically conducted with dumbbells. In the present example, the bench press activity with dumbbells may correspond to user motion that includes the dumbbells being rotated about multiple axis (as compared to motion associated with a barbell).

Based on examples described herein, in some embodiments, the method 700 may include generating, based on machine learning models, predicted exercise activity types based on respective windows (e.g., time duration windows) of data sets identified as likely associated with user motion during an exercise activity and, subsequently, assigning voting scores to the respective windows of data sets. The method 700 may then identify a predicted exercise activity based on the voting system.

At operation 716, the mobile computing device 110 may provide the prediction of the exercise activity for display at a user interface. In some embodiments, the respective windows of data sets may represent one or more user motions for a repetition of the identified exercise activity.

At operation 718, the mobile computing device 110 may be configured to initialize exercise activity repetition set count model operations based on the setBoat sequence of sensor data associated with the predicted exercise activity category.

At operation 720, the mobile computing device 110 may provide a repetition count for the predicted exercise activity for display at the user interface.

In some embodiments, the mobile computing device 110 may be configured to display a main “workout” tab when the user is conducting an exercise activity. The main “workout” tab may include a timer interface that initiates when an exercise activity is identified as started and stops when the exercise activity is detected to have ended.

In some embodiments, the mobile computing device 110 may be configured to detect durations of time when the user is resting between exercise activity sets, and the detected durations of time may be tracked for showing cumulative time spent in-between exercises during a workout.

In some embodiments, the mobile computing device 110 may include features configured to automatically reset rest timers / alarms. In some embodiments, data sets associated with rest timers / alarms may include data sets for a recommendation model for prescribing future exercise activity sequences.

In some embodiments, exercise activity equipment may respectively include a near-field communication tag device (e.g., RFID tag, Bluetooth™ low energy tag, among examples). In some embodiments, client devices such as smart watch devices may include a near-field communication transceiver for detecting corresponding tag devices associated with exercise activity equipment. Thus, the mobile computing devices may be configured to receive data sets for identifying exercise activity equipment (e.g., barbells, dumbbells) and/or resistance measures (e.g., weight values), such that the mobile computing device, such as a smart phone device, may be able to associate weights utilized during predicted exercise activity.

In some embodiments, mobile computing devices may be configured to provide at a user interface recommendations for exercise activity based on an associated user’s profile, based on the user’s prior exercise activity logs, or based on externally determined user data. In some embodiments, externally determined user data may include data sets representing user stress levels over time, user sleep quality or sleep patterns, user’s log of recent diet, or user’s log of other physiological data (e.g., any menstrual cycle data, medication usage data, among other examples). Exercise activity recommendations may be based on holistic data associated with the user’s well-being, such as the user’s sleep cycle patterns, records of whether the user is eating healthy meals based on predefined nutrition guidelines. In some embodiments, externally determined data sets may include data associated with historical patterns of the user’s workout routine (e.g., working out leg exercises every Monday, etc.).

In some embodiments, externally determined user data may be obtained based on interfaces with other applications executed on the mobile computing device. For example, the mobile computing device may obtain a user’s menstrual cycle from third-party applications such as Flo, or may obtain a user’s sleep cycle patterns, diet records, heart rate data or blood pressure data from third-party applications or from applications that may be native to the Apple iOS™ environment. In some embodiments, externally determined user data may include the user’s sleep cycle patterns, diet records, heart rate data or blood pressure data from third-party applications or from applications that may be native to the Android™ environment or other operating system environments.

Based on user data obtained from third party applications, the mobile computing device may be configured to provide recommendations to alter or tweak the user’s daily lifestyle in combination with the user’s exercise activity plans.

In some embodiments, the fitness tracking system may include client devices such as audio devices 130 (FIG. 1), such as Apple AirPods™. In some embodiments, the mobile computing devices described herein may be configured to generate and provide acoustic feedback or acoustic overlay to music that may be played on the audio devices 130 during the users exercise activity. For example, acoustic feedback may include audio prompts to start an exercise activity routine (e.g., count down from 3, 2,1). In some embodiments, acoustic feedback may include audio prompts representing predictions generated by machine learning models described herein, such that the user may provide system feedback in the event that the predictions may not be entirely accurate.

In some embodiments, the mobile computing devices may provide acoustic feedback that notifies the user if the occurrence or duration of rest times appears to be increasing over time, thereby motivating the user to continue the exercise activity. In some embodiments, the acoustic feedback may include audio tracks for providing physiological data, such as heath metrics (e.g., calories burned during the session so far, heart rate being within optimal range, etc.). In some embodiments, the acoustic feedback may include expressions such as “Wow, you are really improving” or “Big lift today! Way to go”, or “Congratulations! New personal best!”, among other expressions. Such acoustic feedback features may be based on detected or predicted characteristics of exercise activity in substantially real time.

In some embodiments, the mobile computing devices may include machine learning models to detect decreases in velocity or intensity of the user’s exercise activity during that workout session, and user feedback may be provided as visual, haptic, or acoustic feedback to encourage the user to “keep going”. In some embodiments, acoustic feedback may include instructional audio clips to guide a user or to provide the user with tips for specific exercise activities with information on muscle groups that the exercise activity may target.

In some embodiments, the mobile computing devices may be configured to provide a post-workout analysis for providing workout results, including total volume lifted, average health metrics, among other examples. The post-workout feedback may include recommended future workout routines, followed by recommended diet plans or recovery times.

In some embodiments, the mobile computing devices may be configured to continuously monitor exercise activity form of a user based on the plurality of data sets representing user motion received from the numerous sensor-based devices, and may be configured to provide acoustic feedback to provide guidance on proper exercise activity form.

In some embodiments, the mobile computing devices may be configured to determine whether a user may reach an exercise activity plateau. An exercise activity plateau may be identified when the user may reach a point of muscle fatigue in their workout, and the user may be no longer able to exercise that muscle group effectively. In some embodiments, machine learning models may be trained to provide recommendations on max weights for repetitions and for best potential weights (e.g., dumbbells) to utilize for maximizing the user’s workout potential.

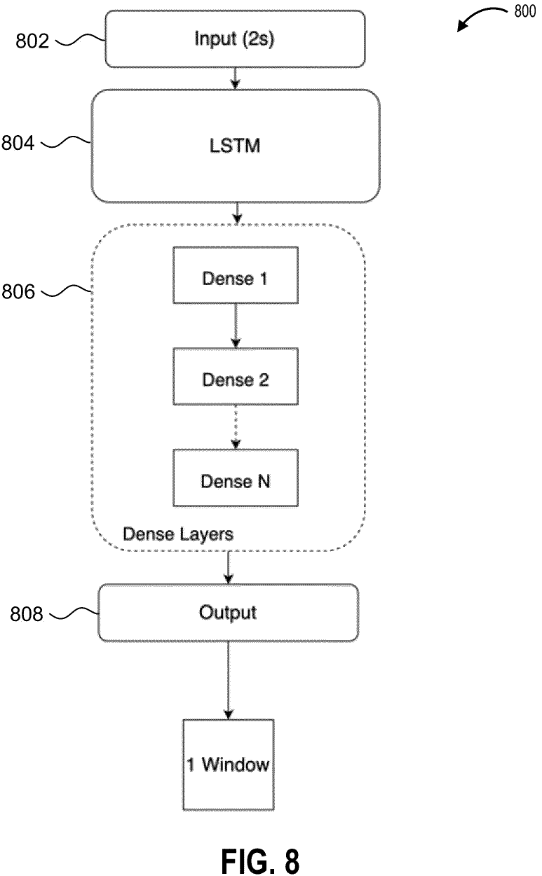

Reference is made to FIG. 8, which illustrates a flowchart of a method 800 of exercise detection, in accordance with embodiments of the present disclosure. The method 800 may include operations conducted by a fitness tracking device worn on a user limb, such as a smart watch device worn on a user’s wrist. The method 800 may include operations conducted by one or more processors of a fitness tracking device. The method 800 may include operations such as data retrievals, data manipulations, data storage, or other operations, and may include computer-executable operations.

FIG. 8 illustrates example architectural blocks representing operations of a machine learning model for generating exercise predictions or generating exercise sequence recommendations, among other feedback signals for a user.

At operation 802, the processor may receive input sensor data. The sensor data may be generated by sensor circuits. The sensor data may represent motion of the user’s limb about at least one sensor axis. In some embodiments, the processor may receive sensor data that has been buffered in 2 second time windows. Any other time quantity per time window may be contemplated.

At operation 804, the processor may propagate the input sensor data to one or a plurality of long short-term memory units representing a neural network for machine learning models.

At operation 806, the processor may conduct operations of a plurality of interconnected dense layers for implementing operations of machine learning models described in the present disclosure. The dense layers may be configured for iterative refinement based on training sensor data for generating exercise predictions or generating exercise sequence recommendations, among other feedback signals for a user.

At operation 808, the processor may generate signals for providing an output for respective windows of input sensor data. For example, based on a buffered 2-second time window of sensor data, the processor may provide an exercise prediction for display on at the fitness tracking device. In some embodiments, the output for the respective windows of input sensor data may be based on one or more operations of FIG. 7, such as operation 712 for generating votes for predicting exercises or operation 714 for identifying from a plurality of predicted exercises associated with votes a predicted exercise activity.

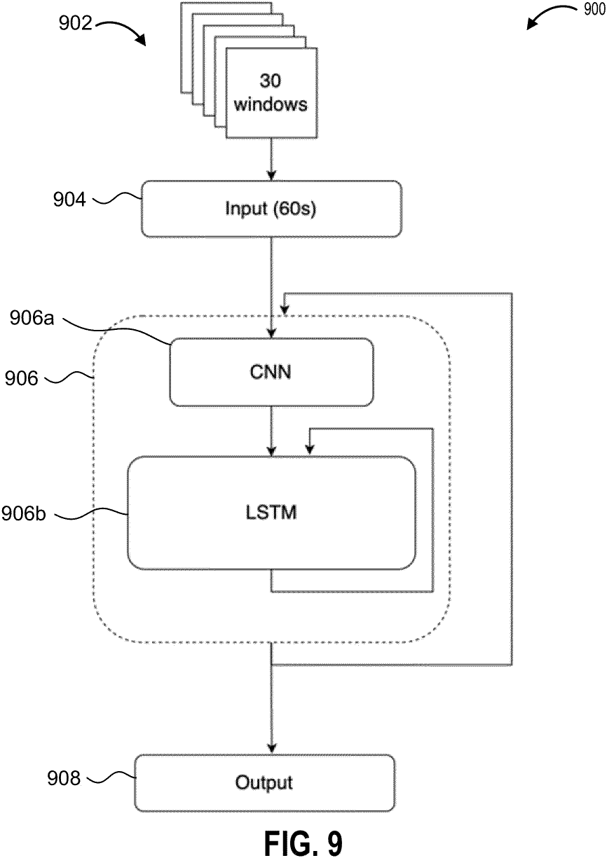

Reference is made to FIG. 9, which illustrates a flowchart of a method 900 of generating exercise activity repetition counts, in accordance with embodiments of the present disclosure. The method 900 may include operations conducted by a fitness tracking device worn on a user limb, such as a smart watch device worn on a user’s wrist. The method 900 may include operations conducted by one or more processors of a fitness tracking device. The method 900 may include operations such as data retrievals, data manipulations, data storage, or other operations, and may include computer-executable operations.

FIG. 9 illustrates example architectural blocks representing operations of a machine learning model for generating exercise activity repetition counts, among other feedback signals for a user.

At operation 902, the processor may buffer a plurality of sensor data windows. For example, as sensor circuits associated with the fitness tracking device generate sensor data representing movement of the user’s limb, the processor may buffer sensor data windows for downstream machine learning model analysis. In some embodiments, the respective sensor data windows may represent sensor data in 2 second time blocks. Other time quantity of respective time blocks may be contemplated.

At operation 904, the processor may obtain a plurality of sensor data windows for generating exercise activity repetition counts. For example, the processor may obtain 30 sensor data windows, respectively representing 2 second time blocks, representing 60 seconds of sensor data while a user is conducting an exercise activity.

At operation 906, the processor may conduct operations for generating exercise activity repetition counts. In some embodiments, the processor may conduct operations similar to operation 718 of FIG. 7 for counting operations based on a predicted exercise category. In some embodiments, operation 906 includes one or more convolutional neural networks (CNN) 906a combined with one or more LSTM units 906b for counting exercise activity repetition counts for the predicted exercise category.

In some embodiments, the LSTM units 906b may be configured as bi-directional LSTM units. For example, when implemented with TensorFlow library operations, the LSTM units 906b may be bi-directional LSTM units. In some other embodiments, the LSTM units 906b may be unidirectional LSTM units.

At operation 908, the processor may generate signals for providing an output for exercise activity repetition count for display or for feedback to the user. In some embodiments, the repetition count may be provided on a substantial real-time basis, such that with each successive cycle of exercise activity cycles, the repetition count is updated.

Referring again to FIG. 1, the fitness tracking platform 100 may include one or more wearable computing devices, such as a smartwatch device 120, an audio device 130, or other wearable computing devices. In some embodiments, the fitness tracking system 100 may be configured to combine data sets from two or more client devices, such as the smartwatch device 120 and the audio device 130, among other wearable devices, to predict an activity type with increased confidence or precision. Such example fitness tracking platforms may be configured to generate exercise activity predictions with increasing confidence or precision.

It may be beneficial to provide a fitness tracking platform configured to generate exercise activity predictions, exercise activity repetition counts, feedback representing exercise form evaluation, among other types of user feedback outputs with increasing confidence or accuracy based on operations of substantially one wearable computing device, such as a smart watch. That is, in some situations, a user may be performing exercises while donning a primary wearable computing device, while leaving other computing devices (e.g., mobile phone, audio headsets, etc.) at other physical locations such that the primary wearable computing device may not be in communication with these other computing devices.

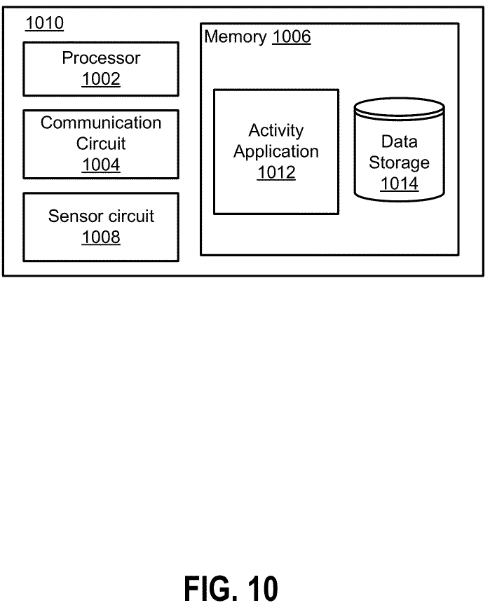

Reference is made to FIG. 10, which illustrates a block diagram of a wearable computing device 1010, in accordance with embodiments of the present disclosure. The block diagram of the wearable computing device 1010 may be an example smart watch, such as an Apple Watch™, Android™-based smart watch, fitness tracking bands, smart eyewear, smart garments, wireless audio devices, or other type of wearable computing devices. The wearable computing device 1010 may be adopted to be worn or donned by a user during one or more exercise activities, such as while working out at a gym or exercising outdoors. The wearable computing device 1010 may be configured as a data-rich device, including sensors for detecting motion, patterns inherent in a sequence of motions, identifiable characteristics of detected motion, physical environment conditions, among other sensor-acquired data.

The wearable computing device 1010 may include a processor 1002, such as a microprocessor or a microcontroller, a digital signal processing processor, an integrated circuit, a field programmable gate array, a reconfigurable processor, or combinations thereof.

The wearable computing device 1010 may include a communication circuit 1004 configured to transmit or receive data messages to or from other computing devices, to access or connect to network resources, or to perform other computing applications by connecting to a network (or multiple networks) capable of carrying data. The communication circuit 1004 may be similar to the communication circuit 204 described with reference to FIG. 2.

The wearable computing device 1010 may include memory 1006. The memory 1006 may store an activity application 1012 including processor-readable instructions for conducting one or more operations described herein, such as for conducting machine learning operations associated with exercise type prediction, operations for providing exercise training recommendations in substantial real-time to a user during user exercise activity, operations for evaluating user exercise from, or operations for providing exercise training recommendations in substantial real-time to a user during an exercise activity.

The wearable computing device 1010 may include a data storage 1014. The data storage 1014 may be a secure data storage, and may store data sets generated by one or more sensor circuits 1008.

The one or more sensor circuits 1008 may include one or more accelerometers, gyroscopes, pedometers, magnetometers, or barometers, among other examples. The sensor circuit 1008 may be configured to generate data sets representing movement or environmental conditions associated with the wearable computing device 1010, such as tilt, shake, rotation, acceleration, or swing, among other examples. As will be described, based on one or more identified user movements or physical environment conditions, the wearable computing device 1010 may be configured to predict or infer a type of exercise activity being undertaken by a user.

In some embodiments, the wearable computing device 1010 may be configured to predict or infer a type of exercise activity in substantial real-time for providing feedback to the user. As an example, a user donning the wearable computing device 1010 may conduct pre-exercise activity, such as approaching a dumbbell, lifting the dumbbell, and beginning several repetitions of bicep curls with the dumbbell. Based on sensor data sets generated by the sensor circuit 1008, the wearable computing device 1010 may be configured to identify the exercise activity prediction (e.g., bicep curl exercise) within several hundred milliseconds, and provide the exercise activity prediction at an output interface within 1 or 2 seconds. Other example time ranges for generating exercise activity predictions and providing the exercise activity prediction at an output interface may be contemplated.

In some situations, a series of sensor data generated by a wearable computing device may be configured to generate an exercise prediction based on detected movement of the wearable computing device. For example, when a user wears a smart watch (e.g., Apple Watch™) on their wrist and engages in one or more weightlifting or other conditioning exercises at a fitness gym, the smart watch may be configured to generate a prediction of the exercise type undertaken by the user. For example, the wearable computing device may be configured to generate predictions that a user is conducting bicep curls, bench presses, shoulder presses, among other example exercises.

In some situations, a given exercise may be performed using two or more different types of equipment. For example, bench press exercises may be performed using dumbbells, barbells, or a Smith machine. In another example, bicep curls may be performed using dumbbells or barbells. In another example, shoulder presses may be performed using barbells or a shoulder press machine. It may be beneficial to provide fitness tracking devices for generating exercise predictions with greater granularity or precision based on sensor data associated with motion of a user’s limb.

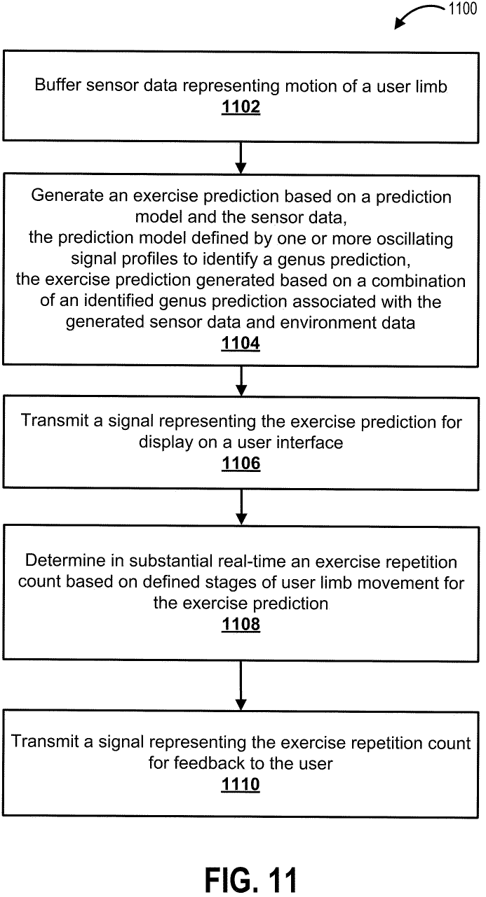

Reference is made to FIG. 11, which illustrates a flowchart of a method 1100 of fitness exercise tracking, in accordance with embodiments of the present disclosure. The method 1100 illustrated in FIG. 11 may include operations conducted by a fitness tracking device worn on a user limb. For example, a fitness tracking device may be a smart watch device or a fitness tracking band configured to be donned on a user’s wrist. The fitness tracking device may be the wearable computing device 1010 of FIG. 10.

The method 1100 may include operations conducted by one or more processors of a fitness tracking device. The method 1100 may include operations, such as data retrievals, data manipulations, data storage, or other operations, and may include computer-executable operations.

In some embodiments, the fitness tracking device configured to be worn on a user limb, such as a user’s wrist, may include a sensor circuit configured to generate sensor data. The sensor circuit may include one or more of accelerometers, gyroscopes, pedometers, magnetometers, or barometers, among examples of sensor devices.

The fitness tracking device may include a processor coupled to the sensor circuit. Further, the fitness tracking device may include memory coupled to the processor and storing processor-executable instructions that, when executed, configure the processor to conduct operations described in the present disclosure.

As described, the sensor circuit may include one or more sensors for detecting movement or other environmental conditions, and may generate a sequence or series of sensor data over time (e.g., time-series sensor data set). The fitness tracking device may store the sensor data for generating exercise predictions, determining exercise activity repetition counts, determining exercise form quality, generate exercise recommendation routines, among other signals, for providing feedback to a user in substantial real-time.

As described, in some situations, a fitness tracking device worn on a user’s limb (e.g., wrist, among other example limbs) may be configured to generate exercise predictions based on a series of sensor data. Users performing exercises, such as bicep curls, bench press exercises, shoulder press exercises, among other examples, may include repetitious characteristics. For instance, when a user conducts bench press exercises, for respective repetitions, the user may engage in a series of arm joint actions having one or more phases, including an eccentric (lowering) phase, horizontal shoulder abduction, elbow flexion, a concentric (lifting) phase, horizontal shoulder abduction, and elbow extension.

In some embodiments, the fitness tracking device may be configured to identify movement associated with the respective phases of an exercise and generate an exercise prediction. Embodiments of operations of the fitness tracking device will be described in the present disclosure.

At operation 1102, the processor is configured to buffer sensor data representing motion of a user limb. The buffered sensor data may be stored in a memory, and the processor may conduct, in substantially real-time or at some future time, operations described in the present disclosure.

The sensor data may include one or a plurality of types of sensor data, such as movement related data from accelerometers, gyroscopes, pedometers, among other examples, for capturing movement characteristics such as tilting, shaking, rotation, acceleration, or swing of the fitness tracking device.

In some embodiments, the sensor circuit may generate sensor data for representing environmental conditions. For example, the sensor circuit may include a magnetometer, and may be configured to generate sensor data representing magnetic field strength or magnetic field direction associated with equipment that may be nearby the user’s limb. For example, the magnetometer sensor may be configured to generate sensor data for inferring whether a user may be grasping a dumbbell having a relatively short length of metal between weight blocks or a barbell having a comparatively longer length of metal between weight blocks. In the present example, the dumbbells and the barbell having weights on opposing sides may respectively have the same mass.

In some situations, sensor data generated by magnetometer sensor circuits may include data signals that exhibit “spikes” when the user is proximal to devices or objects having one or more metal components. In the present example, when the user may be holding a dumbbell device, the magnetometer sensor circuits may generate data signals having “spikes” or distinct characteristics as compared to when the user may be holding a barbell device. In the example of a user holding a dumbbell device, weighted portions having metal construction may be physically more proximal to a user’s wearable computing device when a user is utilizing dumbbell devices.

At operation 1104, the processor is configured to generate an exercise prediction based on a prediction model and the sensor data. The prediction model may be defined by one or more oscillating signal profiles to identify a genus prediction for respective limb movement types about at least one sensor axis. For example, the respective oscillating signal profiles may be associated with one or more stages of user limb movement for an associated exercise type.

Continuing with the example of a user conducting bench press exercises whilst wearing the fitness tracking device on the user’s wrist, the fitness tracking device may detect substantially similar series of acceleration and angular velocity changes while the user conducts respective repetitions of bench press exercises. In some embodiments, the series of acceleration and angular velocity changes associated with the user’s wrist may be represented by an oscillating signal profile characteristic of bench press exercises.

Similarly, the fitness tracking device may detect a different series of acceleration and angular velocity changes while the user conducts numerous repetitions of bicep curl exercises. This series of acceleration and angular velocity changes associated with the user’s wrist may be represented by another oscillating signal profile characteristic of bicep curls.

Thus, at operation 1104, the processor may be configured to predict whether the user is conducting bench press exercises, bicep curls, or other exercises associated with another characterizing oscillating signal profiles.

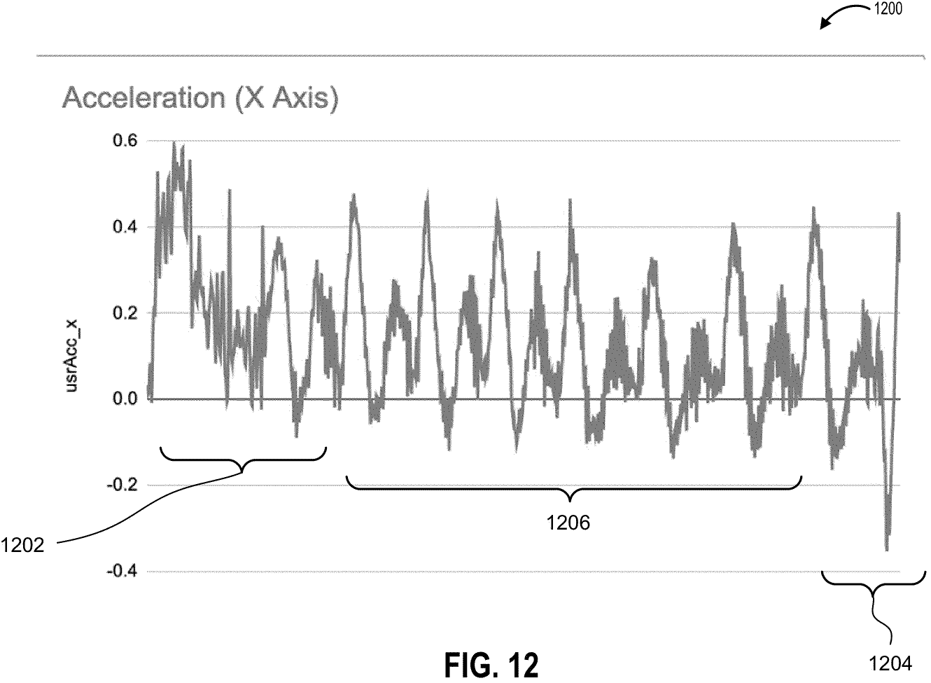

In some embodiments, the prediction model being defined by one or more oscillating signal profiles may represent characteristic oscillating signal profiles representing model or expected sensor data readings while a user is conducting an exercise activity. For a given exercise activity, the prediction model may be defined by a plurality of oscillating signal profiles representing a signal profile for different sensor readings and over different axis. For example, the plurality of oscillating signal profiles may include an oscillating signal profiles representing acceleration about an X-axis of a sensor circuit, acceleration about a Z-axis of the sensor circuit, rotation rate about a Y-axis of the sensor circuit, or roll motion detected by the sensor circuit, among other examples of oscillating signal profiles. Illustrations of graphical plots of sensor data readings against which oscillating signal profiles are analyzed or compared are illustrated in subsequent drawings of the present disclosure, such as in FIGS. 12 to 15.

In some embodiments, the prediction model may be trained on a user-by-user basis, such that the characteristic oscillating signal profiles representing expected sensor data readings while a user is conducting an exercise activity are iteratively refined to be specific to an identified user. Such an example of the prediction model being trained on a user basis may take into account that there may be nuanced or measurable differences in detected user limb movement by different users, which may represent unique anatomical or physiological differences among users.

In some embodiments, predicting the type of exercise based on a characteristic oscillating signal profile may provide a “coarse grain” exercise prediction (e.g., exercise category), or a genus prediction, at least because such an exercise prediction may not be suitable for identifying with high confidence or precision whether the user is conducting the exercises with dumbbells, barbells, or fitness machine equipment. In the present example, the genus prediction may be “bicep curls” or “bench presses”.

Accordingly, at operation 1104, the processor may generate a more granular exercise prediction (e.g., “species” prediction”) based on a combination of the identified genus prediction associated with the generated sensor data and environment data associated with motion of the user limb. A more granular exercise prediction may be “bicep curls with dumbbells”, “bicep curls with a barbell”, bench press with dumbbells, bench press with a Smith machine, among other examples of granular exercise predictions.

Further, a more granular exercise prediction may be bench press exercise on a flat bench or bench press exercise on an inclined bench with a Smith machine. That is, a species prediction may be associated with at least one of equipment type or user position during motion of the user limb.

In some embodiments, the environment data may include sensor data representing pre-exercise motion of the user limb. As an example, when a user is preparing to conduct bench press exercises with dumbbells, pre-exercise motion of the user limb may be represented by sensor data representing user arm movements associated with a user picking up a dumbbell, a user arm movement while walking with the dumbbell to a bench, and a user arm movement to lift the dumbbell into a position to begin a bench press exercise.

In some situations, the above-described user arm movements may be preliminarily identified by the processor as “noise data”, at least, because the above-described user arm movements may not be associated with an oscillating signal profile. As an example, the processor may preliminarily identify whether the above-described user arm movements (e.g., pre-exercise motion) is noise data at operation 702 of FIG. 7.

Continuing with the above example, the processor may determine whether one or more windows of the buffered sensor data represents pre-exercise motion of the user limb, and generate the exercise prediction based on the combination off the genus prediction and the identified pre-exercise motion of the user limb. Such embodiments of processor operations for identifying pre-exercise motion may contribute to providing exercise predictions with increasing granularity or precision. It may be appreciated that determining whether one or more windows of buffered sensor data representing pre-exercise motion of the user limb may be based on prior training data sets representing substantially repeatable pre-exercise motion of the user limb for particular exercises. For example, pre-motion data associated with a user performing steps to setup for bench press exercises with dumbbells may be different than pre-motion data associated with a user performing steps to setup for bench press exercises with a Smith machine.

In some embodiments, the processor may determine whether one or more windows of buffered sensor data represent noise data. Examples of such operations may be similar to operation 702 of FIG. 7. Upon determining that one or more windows of the buffered sensor data represents noise data beyond a threshold quantity of windows (e.g., operation 704 of FIG. 7), the processor may generate the exercise prediction.

In some embodiments, the threshold quantity of windows may represent a time period used to determine that, upon the user halting exercise repetitions (e.g., bench press repetitions), the detected movement of the fitness tracking device (e.g., wrist movement) no longer corresponds to an oscillating signal profile for the bench press repetitions, and that the processor may generate an exercise prediction.

In some embodiments, the processor may generate the exercise prediction based on a combination of the genus prediction and third-party motion data associated with geolocation of the user limb. As an example, a user wearing the fitness tracking device may be performing exercises at a distinct location of a fitness gym. The user may be conducting bench press exercises. The processor may provide a genus prediction, where the user is performing a bench press exercise; but the genus prediction may be unable to precisely identify whether the user is conducting the bench press exercise with a barbell or with a Smith machine.

Thus, the processor may determine based on third-party motion data associated with the geolocation (e.g., distinct location of user at the fitness gym) that other users have conducted bench press exercises with a Smith machine at that distinct location. Accordingly, the third-party motion data may provide additional data for generating an exercise prediction with greater granularity. It may be appreciated that the third-party motion data associated with geolocation markers may be based on machine learning operations at fitness tracking devices of other users at prior points in time.

In some embodiments, the processor may determine, based on geolocation of the fitness tracking device, that the user may be located at a shared fitness class (e.g., cross-fit class). The processor may communicatively receive sensor data representing motion of the user limb of other users at the shared fitness class for informing the exercise prediction of the given user. That is, 20 users participating in a cross-fit class may be presumed to be performing similar exercise motions at substantially similar times. Accordingly, the sensor data representing motion of user limbs of other users at a shared fitness class may be environment data for generating an exercise prediction for the given user of the fitness tracking device.

In some situations, exercise activity may be associated with relatively low range of user limb motion. For example, when conducting plank-type stretching exercises, wall sitting exercises, or leg press exercises, among other examples, users may not move one or more limbs with a large range of motion. It may be beneficial to generate exercise predictions based on non-movement type user data. In some embodiments, the processor may generate the exercise prediction based on a combination of the generated genus prediction and physiological user metrics over an exercise time period. For example, a fitness tracking device (e.g., smart watch device) may include sensor circuits for generating heart rate data or other types of physiological data. Such heart rate data may be example physiological user data that, in combination with the generated genus prediction, may be identified for generating an increasingly granular exercise prediction. For instance, a user’s heart rate may increase or fluctuate based on a characteristic pattern when conducting plank-type stretching exercises. Accordingly, in some embodiments, the processor may generate exercise predictions based on a combination of the generated genus prediction and physiological user metrics associated with the machine learning model operations of the present disclosure.

In some embodiments, the fitness tracking device having the sensor circuit may include a magnetometer sensor. Further, the environment data may include sensor data representing at least one of magnetic field strength or magnetic field direction. The sensor data may be based on magnetic fields associated with equipment that the user’s limb may interact with. For example, barbells or dumbbells may include metal grip components. In some examples, the sensor data may provide an indication of the magnetic field strength or magnetic field direction associated with a user holding a dumbbell whilst performing exercises. Accordingly, the environment data including sensor data representing at least one of magnetic field strength or magnetic field direction may be for predicting presence or positioning of exercise equipment associated with motion of the user limb.

In some embodiments, the processor may predict or infer weight being supported by the user’s limb based on a combination of magnetometer sensor data, movement or motion data of the user, or physiological user data based on learned machine learning models over time.

Embodiments of operations described with reference to the method 1100 of FIG. 11 may supplement genus predictions (which may be based on one or more oscillating signal profiles) with environment data associated with the user limb, thereby generating exercise predictions based on motion of the user limb with increased confidence and precision.

At operation 1106, the processor may transmit a signal representing the exercise prediction for feedback to a user. In some embodiments, the signal representing the exercise prediction may be for displaying, on a display interface of the fitness tracking device, the exercise prediction. For example, a displayed message may indicate that the exercise prediction is bench press with a Smith machine, or that the exercise prediction is a shoulder press exercise with a barbell.

In some embodiments, the display interface may include one or more user interface elements for receiving confirmation on whether the exercise prediction is correct or representative of the user’s motions. In the event that the user provides input that the exercise prediction is correct, the processor may conduct operations for validating the prediction model. In the event that the user provides input that the exercise prediction is incorrect or that the exercise prediction is not fully accurate (e.g., bench press exercises with dumbbells versus bench press exercises with barbell), the processor may conduct machine learning operations for updating the prediction model.

In some embodiments, in the event that the processor receives user input that the exercise prediction is incorrect or that the exercise prediction is not fully accurate, the processor may transmit a signal for displaying one or more other suggestions for the exercise prediction based on the prediction model operations. In some embodiments, the prediction model operations are based on a combination of machine learning operations and heuristics.

In some embodiments, the prediction model may be based on machine learning operations of Tensor-Flow operations. In some embodiments, the prediction model may be based on machine learning operations of Apple CoreML™ operations. In some embodiments, the prediction model may be based on a series of convolutional layers, long-short term memory (LSTM) artificial neural network layers, or dense recurrent neural network layers.

Some embodiments of the present disclosure may include machine learning models based on one or a combination of TensorFlow™ library operations or CoreML™ library operations. In an embodiment where a fitness tracking device is an Apple Watch™, machine learning models for generating exercise predictions may be generated and trained based on TensorFlow™ library operations and converted to CoreML™ operations, such that operations for generating exercise predictions or exercise repetition counts, among other operations, may be conducted on an Apple Watch™. In other examples, machine learning models for generating exercise predictions may be generated and trained based on TensorFlow™ library operations and converted to other model operations for execution on alternate operating systems (e.g., operating systems for Android-based smart watch devices, Garmin™ smart watch devices, among examples).

As described, in some embodiments, the respective oscillating signal profiles may represent or define one or more stages of user limb movement for an associated exercise. As an example, for a bench press exercise, the oscillating signal profiles may represent sensor data characteristics associated with eccentric (lowering) phase or concentric (lifting) phase of the bench press exercise.

Thus, at operation 1108, the processor may determine in substantial real-time an exercise repetition count based on defined stages of user limb movement for the exercise prediction. For example, the processor may increment a repetition count upon detecting that a substantially complete cycle of stages of user limb movement for a particular exercise (e.g., at least detection of eccentric phase and concentric phase of a bench press exercise).

At operation 1110, the processor may transmit a signal representing the exercise repetition count for feedback to the user. For example, the signal may be configured to display a dynamic repetition count for the predicted user in substantial real-time following the completion of a repetition of the predicted exercise. In another example, the signal may be configured to provide haptic or acoustic output to the user upon completion of the predicted exercise.

In some embodiments, environment data may include sensor data representing post-exercise motion of the user limb. For example, a user performing bicep curl exercises with dumbbells may complete a repetition set and place the dumbbells onto a dumbbell rack. Sensor data representing motion of the user arm when the user places the dumbbells onto the rack may trigger a final count of the buffered sensor data for refining the exercise prediction or the repetition count.

In some embodiments, the fitness tracking device may be configured to provide substantial real-time feedback to a user during an exercise repetition set of the user’s limb motion is representative of improper physical form, as compared to a benchmark motion form for the predicted exercise.

In some embodiments, the fitness tracking device may be configured to store sensor data representing benchmark motion for one or more fitness exercises. For example, sensor data set representing benchmark motion for overhead press exercises may be based on identified motion characteristics that are representative of identified optimal exercise form.

In some embodiments, the processor may determine form quality of motion of the user limb associated with the exercise prediction based on comparing the buffered sensor data with benchmark sensor data representing benchmark motion for the predicted exercise. Upon the processor identifying that the buffered sensor data represents user limb motion deviation greater than a threshold amount from benchmark sensor data, the processor may transmit a signal for providing feedback to the user that the determined physical form of motion of the user limb may not be optimal.

Reference is made to FIGS. 12 to 15, which graphical plots of sensor data generated by a sensor during an exercise activity, in accordance with embodiments of the present application. As illustrating examples, the graphical plots of sensor data shown in FIGS. 12 to 15 represent a user’s wrist movement about respective sensor axis during a “dumbbell lat raise” exercise.

In particular, FIG. 12 illustrates an example graphical plot 1200 of acceleration sensor data associated with an X-axis generated by a sensor during a “dumbbell lat raise” exercise. The sensor data illustrated in FIG. 12 may show sensor data readings (along a y-axis of the graphical plot) versus time (along an x-axis of the graphical plot). The sensor data readings may include sensor data representing pre-activity movement 1202, sensor data representing movement during an exercise activity 1206, and post-activity movement 1204.

As described in the present disclosure, in some embodiments, the processor may generate exercise predictions based on a determined genus prediction and at least one of pre-activity movement 1202 or post-activity movement 1204. The pre-activity movement 1202 or post-activity movement 1204 sensor data may be used for providing exercise predictions with greater granularity or precision. For example, pre-activity movement 1202 sensor data may represent a user setting up to lift dumbbells prior to conducting numerous repetitions of the target exercise activity. Sensor data representing the target exercise activity 1206 (e.g., dumbbell lat raise exercise) may be between sensor data representing the pre-activity movement 1202 and the post-activity movement 1204. In some examples, post-activity movement 1204 sensor data may represent a user placing dumbbells onto a rack or onto the ground upon completion of the target exercise activity.

In some embodiments, the processor may conduct machine learning operations for comparing the sensor data representing the target exercise activity 1206 against one or more oscillating signal profiles (described in the present disclosure) for identifying genus predictions. In the present example, a genus prediction may be a “lat raise” exercise. Such a genus prediction may be unsuitable for identifying whether the “lat raise” exercise is conducted with dumbbells or other exercise equipment. Accordingly, in some embodiments, the processor may generate an exercise prediction with greater precision based on a combination of the genus prediction and pre-activity movement 1202 or post-activity movement 1204 sensor data. Other types of environment data for combining with the genus prediction to provide an increasingly precise exercise prediction are contemplated.

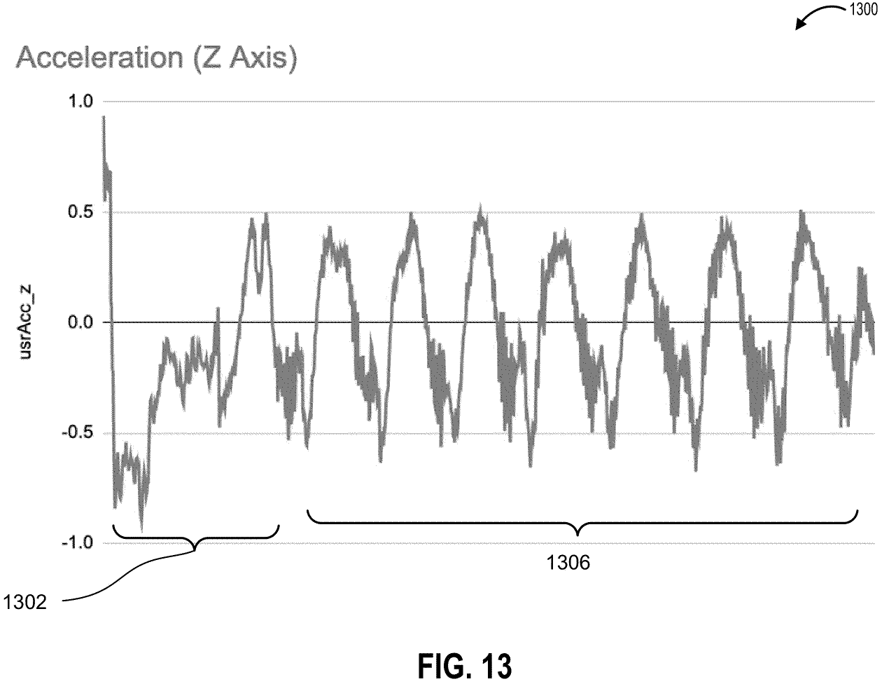

Reference is made to FIG. 13, which illustrates an example graphical plot 1300 of acceleration sensor data associated with a Z-axis generated by a sensor during a “dumbbell lat raise” exercise. The sensor data illustrated in FIG. 13 may show sensor data readings (along a y-axis of the graphical plot) versus time (along an x-axis of the graphical plot). In the present illustrated example, the graphical plot 1300 may include pre-activity movement 1302 sensor data about a sensor Z-axis that corresponds to pre-activity movement 1202 sensor data about a sensor X-axis (see FIG. 12).

FIG. 13 also illustrates sensor data representing the target exercise activity 1306. The sensor data representing the target exercise activity 1306 may correspond to cyclic movement of the user limb during the target exercise activity. As shown in FIG. 13, the sensor data representing the target sensor exercise activity 1306 may include substantially repeating sensor reading characteristics. In the example illustrated in FIG. 13, there may not be sensor data representing post-activity movement about the sensor Z-axis for corresponding to sensor data representing post activity movement 1204 of FIG. 12.

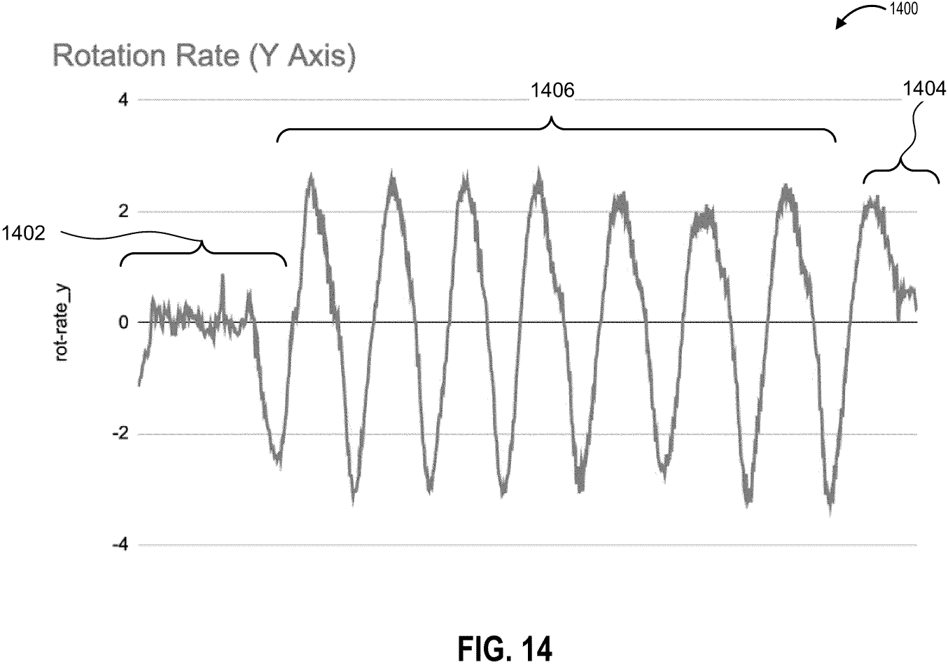

FIG. 14 illustrates an example graphical plot 1400 of sensor data representing rotational rate data about a sensor Y-axis during a “dumbbell lat raise” exercise. The sensor data illustrated in FIG. 14 may show sensor data readings (along a y-axis of the graphical plot) versus time (along an x-axis of the graphical plot). In the present illustrated example, the graphical plot 1400 includes pre-activity 1402 sensor data about a sensor Y-axis, target exercise activity 1406 sensor data about the sensor Y-axis, and post-activity 1404 sensor data about the sensor Y-axis. The respective illustrations of pre-activity 1402, target exercise activity 1406, and post-activity 1404 sensor data may correspond to respective categories of sensor data in FIGS. 12 and 13.

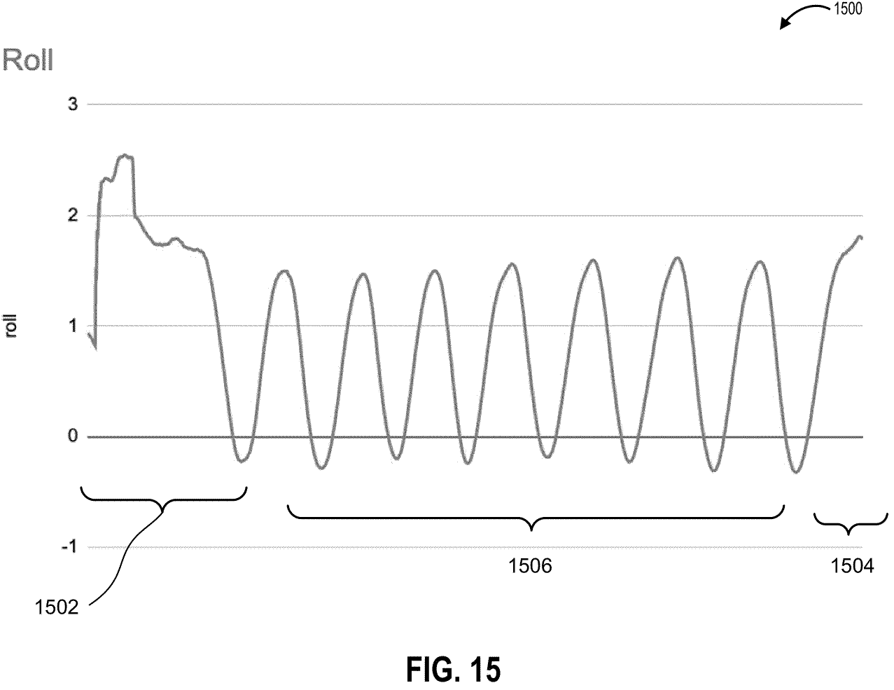

FIG. 15 illustrates an example graphical plot 1500 of sensor data representing roll data during a “dumbbell lat raise” exercise. The sensor data illustrated in FIG. 15 may show sensor data readings (along a y-axis of the graphical plot) versus time (along an x-axis of the graphical plot). In the present illustrated example, the graphical plot 1500 includes pre-activity 1502 roll sensor data, target exercise activity 1506 roll sensor data, and post-activity 1506 roll sensor data, which may correspond to respectively corresponding categories of sensor data in FIGS. 12, 13, and 14, as applicable.

In some embodiments, operations of prediction models described in the present disclosure may generate one or more feedback signals for a user based on genus predictions based on defined oscillating signal profiles and buffered sensor data. Example illustrations of buffered sensor data is shown in FIGS. 12 to 15, which may be used for generating genus predictions based on models defined by oscillating signal profiles. The respective oscillating signal profiles may be defined for target exercise activity and for one or a plurality of sensor types or sensor axis.

The term “connected” or “coupled to” may include both direct coupling (in which two elements that are coupled to each other contact each other) and indirect coupling (in which at least one additional element is located between the two elements).

Although the embodiments have been described in detail, it should be understood that various changes, substitutions and alterations can be made herein without departing from the scope. Moreover, the scope of the present disclosure is not intended to be limited to the particular embodiments of the process, machine, manufacture, composition of matter, means, methods and steps described in the specification.

As one of ordinary skill in the art will readily appreciate from the disclosure, processes, machines, manufacture, compositions of matter, means, methods, or steps, presently existing or later to be developed, that perform substantially the same function or achieve substantially the same result as the corresponding embodiments described herein may be utilized. Accordingly, the appended claims are intended to include within their scope such processes, machines, manufacture, compositions of matter, means, methods, or steps.

The description provides many example embodiments of the inventive subject matter. Although each embodiment represents a single combination of inventive elements, the inventive subject matter is considered to include all possible combinations of the disclosed elements. Thus if one embodiment comprises elements A, B, and C, and a second embodiment comprises elements B and D, then the inventive subject matter is also considered to include other remaining combinations of A, B, C, or D, even if not explicitly disclosed.

The embodiments of the devices, systems and methods described herein may be implemented in a combination of both hardware and software. These embodiments may be implemented on programmable computers, each computer including at least one processor, a data storage system (including volatile memory or non-volatile memory or other data storage elements or a combination thereof), and at least one communication interface.

Program code is applied to input data to perform the functions described herein and to generate output information. The output information is applied to one or more output devices. In some embodiments, the communication interface may be a network communication interface. In embodiments in which elements may be combined, the communication interface may be a software communication interface, such as those for inter-process communication. In still other embodiments, there may be a combination of communication interfaces implemented as hardware, software, and combination thereof.

Throughout the foregoing discussion, numerous references may be made regarding servers, services, interfaces, portals, platforms, or other systems formed from computing devices. It should be appreciated that the use of such terms is deemed to represent one or more computing devices having at least one processor configured to execute software instructions stored on a computer readable tangible, non-transitory medium. For example, a server can include one or more computers operating as a web server, database server, or other type of computer server in a manner to fulfill described roles, responsibilities, or functions.

The technical solution of embodiments may be in the form of a software product. The software product may be stored in a non-volatile or non-transitory storage medium, which can be a compact disk read-only memory (CD-ROM), a USB flash disk, or a removable hard disk. The software product includes a number of instructions that enable a computer device (personal computer, server, or network device) to execute the methods provided by the embodiments.

The embodiments described herein are implemented by physical computer hardware, including computing devices, servers, receivers, transmitters, processors, memory, displays, and networks. The embodiments described herein provide useful physical machines and particularly configured computer hardware arrangements.

As can be understood, the examples described above and illustrated are intended to be exemplary only.

What is claimed is:

1. A fitness tracking device worn on a user limb comprising:
a sensor circuit configured to generate sensor data;
a processor coupled to the sensor circuit;
a memory coupled to the processor and storing processor-executable instructions that, when executed, configure the processor to:
buffer sensor data associated with motion of the user limb;
generate an exercise prediction based on a prediction model and the sensor data, the prediction model defined by one or more oscillating signal profiles to identify genus predictions for respective limb movement types about at least one sensor axis, wherein the exercise prediction is generated based on a combination of an identified genus prediction associated with the generated sensor data and environment data associated with motion of the user limb; and
transmit a signal representing the exercise prediction for display on a user interface.

2. The fitness tracking device of claim 1, wherein the identified genus prediction represents an exercise category, and wherein the generated exercise prediction represents a species prediction associated with at least one of equipment type or user position during motion of the user limb.

3. The fitness tracking device of claim 1, wherein the respective oscillating signal profiles define one or more stages of user limb movement for an associated exercise type,
and wherein the processor-executable instructions, when executed, configure the processor to: determine in substantial real-time an exercise repetition count based on the defined stages of user limb movement for the exercise prediction.

4. The fitness tracking device of claim 3, wherein the environment data includes sensor data representing post-exercise motion of the user limb, and wherein determining the exercise repetition count is based on identifying post-exercise motion of the user limb.

5. The fitness tracking device of claim 1, wherein the processor-executable instructions, when executed, configure the processor to:
determine whether one or more windows of the buffered sensor data represent noise data; and
upon determining that one or more windows of the buffered sensor data represents noise data beyond a threshold quantity of windows, generate the exercise prediction.

6. The fitness tracking device of claim 1, wherein the environment data includes sensor data representing pre-exercise motion of the user limb, and wherein the processor-executable instructions, when executed, configure the processor to:
determine that one or more windows of the buffered sensor data represents pre-exercise motion of the user limb; and
generate the exercise prediction based on the combination of the genus prediction and the identified pre-exercise motion of the user limb.

7. The fitness tracking device of claim 1, wherein the sensor circuit includes a magnetometer sensor, and wherein the environment data includes sensor data representing at least one of magnetic field strength or magnetic field direction, and wherein the buffered sensor data includes at least one of magnetic field strength or magnetic field direction data for predicting exercise equipment apparatus associated with motion of the user limb.

8. The fitness tracking device of claim 1, wherein generating the exercise prediction is based on a combination of the genus prediction and third-party motion data associated with geolocation of the user limb.

9. The fitness tracking device of claim 1, wherein the processor-executable instructions, when executed, configure the processor to:
determine form quality of motion of the user limb associated with the exercise prediction based on comparing the buffered sensor data with benchmark sensor data representing benchmark motion form for the predicted exercise; and
transmit a signal representing the determined form quality of motion of the user limb for feedback to the user.

10. The fitness tracking device of claim 1, comprising at least one of a smart watch, a fitness tracking band, wireless audio devices, or smart garments.

11. A method of fitness exercise tracking comprising:
buffering sensor data associated with motion of the user limb, the sensor data generated by a sensor circuit;
generating an exercise prediction based on a prediction model and the sensor data, the prediction model defined by one or more oscillating signal profiles to identify genus predictions for respective limb movement types about at least one sensor axis, wherein the exercise prediction is generated based on a combination of an identified genus prediction associated with the generated sensor data and environment data associated with motion of the user limb; and
transmit a signal representing the exercise prediction for display on a user interface.

12. The method of claim 11, wherein the identified genus prediction represents an exercise category, and wherein the generated exercise prediction represents a species prediction associated with at least one of equipment type or user position during motion of the user limb.

13. The method of claim 11, wherein the respective oscillating signal profiles define one or more stages of user limb movement for an associated exercise type,
and wherein the method includes determining in substantial real-time an exercise repetition count based on the defined stages of user limb movement for the exercise prediction.

14. The method of claim 13, wherein the environment data includes sensor data representing post-exercise motion of the user limb, and wherein determining the exercise repetition count is based on identifying post-exercise motion of the user limb.

15. The method of claim 11, comprising:
determining whether one or more windows of the buffered sensor data represent noise data; and
upon determining that one or more windows of the buffered sensor data represents noise data beyond a threshold quantity of windows, generating the exercise prediction.

16. The method of claim 11, wherein the environment data includes sensor data representing pre-exercise motion of the user limb, and wherein the method includes:
determining that one or more windows of the buffered sensor data represents pre-exercise motion of the user limb; and
generating the exercise prediction based on the combination of the genus prediction and the identified pre-exercise motion of the user limb.

17. The method of claim 11, wherein the sensor circuit includes a magnetometer sensor, and wherein the environment data includes sensor data representing at least one of magnetic field strength or magnetic field direction, and wherein the buffered sensor data includes at least one of magnetic field strength or magnetic field direction data for predicting exercise equipment apparatus associated with motion of the user limb.

18. The method of claim 11, wherein generating the exercise prediction is based on a combination of the genus prediction and third-party motion data associated with geolocation of the user limb.

19. The method of claim 11, comprising:
determining form quality of motion of the user limb associated with the exercise prediction based on comparing the buffered sensor data with benchmark sensor data representing benchmark motion form for the predicted exercise; and
transmitting a signal representing the determined form quality of motion of the user limb for feedback to the user.

20. A non-transitory computer-readable medium or media having stored thereon machine interpretable instructions which, when executed by a processor, cause the processor to perform a computer-implemented method for a fitness tracking device, the method comprising:
buffering sensor data associated with motion of the user limb, the sensor data generated by a sensor circuit;
generating an exercise prediction based on a prediction model and the sensor data, the prediction model defined by one or more oscillating signal profiles to identify genus predictions for respective limb movement types about at least one sensor axis, wherein the exercise prediction is generated based on a combination of an identified genus prediction associated with the generated sensor data and environment data associated with motion of the user limb; and
transmitting a signal representing the exercise prediction for display on a user interface.
